(19) United States
(12) Patent Application Publication
(10) Pub. No.: US 2007/0067785 A1
(43) Pub. Date: Mar. 22, 2007

(54) Recording and reproducing apparatus for photosensitive recording medium

(75) Inventors: Katsuyoshi Asakura, Kanagawa (JP); Tomoyuki Takahashi, Kanagawa (JP); Yoshihisa Usami, Shizuoka (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/522,393

(22) Filed: Sep. 18, 2006

(30) Foreign Application Priority Data
Sep. 16, 2005 (JP) P2005-269792
Sep. 16, 2005 (JP) P2005-269841
Sep. 30, 2005 (JP) P2005-289003

(51) Int. Cl. G11B 17/04; G11B 23/03

(52) U.S. Cl. 720/643; 720/744

(57) ABSTRACT

A recording and reproducing apparatus for a photosensitive recording medium, the apparatus comprising: a case as defined herein; an loading slot shutter as defined herein; an unlocking mechanism as defined herein; and a shutter opening mechanism as defined herein, wherein the unlocking mechanism starts the unlocking of the second locking member immediately after a leading end of the photosensitive recording medium cartridge is inserted into the loading slot and starts the unlocking of the first locking member immediately after the second locking member is unlocked, and the shutter opening mechanism opens the shutter of the photosensitive recording medium cartridge when the photosensitive recording medium cartridge reaches a predetermined position.

### FIELD OF THE INVENTION

The present invention relates to a recording and reproducing apparatus for a photosensitive recording medium such as a holographic recording medium, and more particularly, to a recording and reproducing apparatus for a photosensitive recording medium, which can record data in a light shielded state in a cartridge housing and holding the photosensitive recording medium or reproduce the recorded data therefrom.

### BACKGROUND OF THE INVENTION

A holographic recording medium on which data are holographically recorded has been invented (e.g. see JP-A-2004-029476). The holographic recording medium is a photosensitive recording medium in which holographic recording layers made of a photosensitive material are formed on a disk-shaped support member. It is possible to obtain a data recording capacity greater than that of a DVD which is a recording medium having been widely spread, by recording data in multi layers thereof using interference fringes of laser beams. Since exposure of the holographic recording layers to light or attachment of dust on the holographic layers badly affects performance of the holographic recording medium, the holographic recording medium is housed and handled in a cartridge having a light shielding function and a dust-proof function (e.g. see JP-A-2003-317422 (corresponding to US 2003/0198177 A1)).

In the invention described in JP-A-2004-029476, the holographic recording medium is housed in a cartridge similar to the cartridge of a DVD-RAM. The cartridge is made of a material having low transmittance of light beams in a wavelength band affecting the holographic layers. Although the detailed configuration of the cartridge is not described in JP-A-2004-029476, it is considered that the cartridge has the same configuration as the cartridge described in JP-A-2003-317422 (corresponding to US 2003/0198177 A1).

In the invention described in JP-A-2003-317422 (corresponding to US 2003/0198177 A1), the cartridge is made of a material blocking light beams of colors sensitive to the holographic recording layers and a sponge-like light-shielding material is attached to a mating point of a movable portion exposing the holographic recording medium to the outside. In addition, the cartridge includes a cartridge body rotatably receiving a recording medium, an opening provided in the cartridge body so as to expose a part of the recording medium to the outside, and a shutter opening and closing the opening.

### SUMMARY OF THE INVENTION

In the known apparatus receiving the cartridge having the shutter to record and reproduce data, an unlocking mechanism starts unlocking a photosensitive recording medium cartridge when the photosensitive recording medium cartridge reaches a predetermined reproducing and recording position and a shutter opening mechanism opens the shutter of the photosensitive recording medium cartridge after the photosensitive recording medium cartridge is unlocked.

FIG. 17 is a flowchart illustrating a flow of opening the shutter of the photosensitive recording medium cartridge in a known apparatus. Configurations of first and second unlocking members and first and second locking members will be described later.

In the figure, when the cartridge reaches a recording and reproducing position in the apparatus (step S21), a second unlocking member goes into action S22 to unlock a second locking member (S23). When the second locking member is unlocked, a first unlocking member goes into action (S24) to unlock a first locking member (S25). When the first locking member is unlocked, the shutter is opened (S26) and when the shutter is opened (S27), the recording and reproducing is possible.

In the known apparatus, when the photosensitive recording cartridge reaches the recording and reproducing position, the locked state is released and then the shutter is opened. Accordingly, the recording and reproducing of data requires a long time.

The present invention is contrived in consideration of such problems. A first task of the invention is to provide a recording and reproducing apparatus for a photosensitive recording medium which can reduce the time until the recording and reproducing is possible after a cartridge is loaded into the apparatus.

A second task of the invention is to provide with a simple structure a recording and reproducing apparatus for a photosensitive recording medium in which a shutter can be opened when a cartridge reaches a predetermined position in the apparatus by releasing a locked state before the cartridge reaches the predetermined position in the apparatus, not thereafter, thereby reducing the time until the recording and reproducing is possible. In addition, by checking using an illumination sensor that no external light exists in the recording and reproducing apparatus and then opening the shutter, the photosensitive recording medium in the cartridge can be protected from unintentional light.

In order to accomplish the first task, according to a first aspect of the invention, there is provided a recording and reproducing apparatus for a photosensitive recording medium, the apparatus comprising: a case having a loading slot, which a photosensitive recording medium cartridge can be inserted into, and an inner space shielded from the outside, the photosensitive recording medium cartridge having a cartridge body rotatably receiving the photosensitive recording medium and having an opening for exposing a central portion and a recording surface of the photosensitive recording medium to the outside, a shutter fitted to the outside of the cartridge body and disposed to be movable between a closing position where the opening is closed and an opening position where the opening is opened, and a locking mechanism for locking the shutter at the closing position; an loading slot shutter which is disposed in the case so as to open and close the loading slot and which shields the loading slot from the outside when the loading slot is closed; an unlocking mechanism which is disposed in the case and which is for unlocking locking members of a locking mechanism, the locking mechanism having a first locking member which is movable between a first locking position for blocking movement of the shutter to the opening position and a first unlocking position for permitting the movement of the shutter to the opening position and a second locking member which is movable between a second locking position for blocking movement of the first locking member to the first unlocking position and a second unlocking position for permitting the movement of the first locking member to the first unlocking position; and a shutter opening mechanism which is disposed in the case and which is for opening the shutter of the photosensitive recording medium cartridge, wherein the unlocking mechanism starts the unlocking of the second locking member immediately after a leading end of the photosensitive recording medium cartridge is inserted into the loading slot and starts the unlocking of the first locking member immediately after the second locking member is unlocked, and wherein the shutter opening mechanism opens the shutter of the photosensitive recording medium cartridge when the photosensitive recording medium cartridge reaches a predetermined position.

In the recording and reproducing apparatus for a photosensitive recording medium according to the first aspect, the unlocking mechanism may be movable in a horizontal direction in the case.

The recording and reproducing apparatus for a photosensitive recording medium may further comprise an end detecting sensor detecting that the leading end of the photosensitive recording medium cartridge is inserted into the loading slot. Here, the unlocking mechanism may be allowed to move in the horizontal direction in response to the output of the end detecting sensor.

In the recording and reproducing apparatus for a photosensitive recording medium, the shutter may have a bent portion, which is bent toward the cartridge body, at an outer circumferential edge of the shutter and the cartridge body may have a protruded portion formed at a position corresponding to the outer circumferential edge.

In the recording and reproducing apparatus for a photosensitive recording medium, the bent portion may be formed at an end of the outer circumferential edge close to the opening position of the shutter.

In the recording and reproducing apparatus for a photosensitive recording medium, the shutter may have a first light shielding plate portion sliding so as to open and close the opening, a second light shielding plate portion rising vertically from an end of the first light shielding plate portion close to the opening position of the shutter, and a third light shielding plate portion rising vertically from the second light shielding plate portion in a direction in which the shutter is closed. Here, the cartridge body may be provided with a protrusion which is interposed between the first light shielding plate portion and the third light shielding plate portion when the shutter is at the closing position.

The recording and reproducing apparatus for a photosensitive recording medium, the shutter may have a first light shielding plate portion sliding so as to open and close the opening and a second light shielding plate portion rising vertically from an end of the first light shielding portion close to the opening position of the shutter. Here, the protruded portion may have a protrusion top surface which is provided so as to be opposed to the first light shielding plate portion when the shutter is at the closing position, and a protrusion side surface which is provided so as to be opposed to the second light shielding plate portion when the shutter is at the closing position.

In the recording and reproducing apparatus for a photosensitive recording medium, the shutter may have a first light shielding plate portion sliding so as to open and close the opening, a second light shielding plate portion rising vertically from an end of the first light shielding plate portion close to the opening position of the shutter, and a third light shielding plate portion rising vertically from the second light shielding plate portion in a direction in which the shutter is opened. Here the cartridge body may have a protrusion top surface which is provided so as to be opposed to the first light shielding plate portion when the shutter is at the closing position, a protrusion side surface which is provided so as to be opposed to the second light shielding plate portion when the shutter is at the closing position, and a shutter sliding surface offset inwardly in the protrusion top surface and provided so as to be opposed to the third light shielding plate portion when the shutter is at the closing position.

In the recording and reproducing apparatus for a photosensitive recording medium, an inner surface of the cartridge body opposed to the photosensitive recording medium and an outer surface opposed to the shutter may be matted or embossed with a surface roughness Ra of 5 to 20 μm.

In the recording and reproducing apparatus for a photosensitive recording medium, the cartridge body may include a first shell having a substantially plate shape and a second shell welded to the first shell to overlap with each other, the first shell and the second shell may be made of an equal or similar thermoplastic material, and the other components including the shutter may be made of a material different from that of the first shell and the second shell.

In the recording and reproducing apparatus for a photosensitive recording medium, 0.01 weight % to 5.00 weight % of a light shielding material may be added to a plastic used for forming each of the first shell, the second shell, and the shutter.

In the recording and reproducing apparatus for a photosensitive recording medium, 0.01 weight % to 2.00 weight % of carbon black may be added to a plastic used for forming each of the first shell, the second shell, and the shutter.

In the recording and reproducing apparatus for a photosensitive recording medium, 0.1 weight % to 5.0 weight % of a silicon-based lubricant may be added to a plastic used for forming each of the first shell, the second shell, and the shutter.

In another aspect of the invention, a holographic recording medium cartridge as the photosensitive recording medium is received in the photosensitive recording medium cartridge.

In the recording and reproducing apparatus for a photosensitive recording medium according to the first aspect of the invention, it is possible to obtain a recording and reproducing apparatus for a photosensitive recording medium in which a photosensitive recording medium is received in a cartridge which is shielded from light with an erroneous opening preventing countermeasure and in which the time until a recording or reproducing operation can be performed after the cartridge is inserted into the light-shielded recording and reproducing apparatus can be reduced.

In order to accomplish the first task, according to a second aspect of the invention, there is provided a recording and reproducing apparatus for a photosensitive recording medium, the apparatus comprising: a case having a loading slot, which a photosensitive recording medium cartridge can be inserted into, and an inner space shielded from the outside, the photosensitive recording medium cartridge having a cartridge body rotatably receiving the photosensitive recording medium and having an opening for exposing a central portion and a recording surface of the photosensitive recording medium to the outside, a shutter fitted to the outside of the cartridge body and disposed to be movable between a closing position where the opening is closed and an opening position where the opening is opened, and a locking mechanism for locking the shutter at the closing position; an loading slot shutter which is disposed in the case so as to open and close the loading slot and which shields the loading slot from the outside when the loading slot is closed; an unlocking mechanism which is disposed in the case and which is for unlocking locking members of a locking mechanism, the locking mechanism having a first locking member which is movable between a first locking position for blocking movement of the shutter to the opening position and a first unlocking position for permitting the movement of the shutter to the opening position and a second locking member which is movable between a second locking position for blocking movement of the first locking member to the first unlocking position and a second unlocking position for permitting the movement of the first locking member to the first unlocking position; and a shutter opening mechanism which is disposed in the case and which is for opening the shutter of the photosensitive recording medium cartridge, wherein the unlocking mechanism starts the unlocking of the second locking member immediately after a leading end of the photosensitive recording medium cartridge is inserted into the loading slot and starts the unlocking of the first locking member immediately after the second locking member is unlocked, and wherein the shutter opening mechanism opens the shutter of the photosensitive recording medium cartridge immediately after the first locking member is unlocked and the shutter is opened when the photosensitive recording medium cartridge reaches a predetermined position.

In the recording and reproducing apparatus for a photosensitive recording medium according to the second aspect, the unlocking mechanism and the shutter opening mechanism may be movable in a horizontal direction in the case.

The recording and reproducing apparatus for a photosensitive recording medium may further comprise an end detecting sensor detecting that the leading end of the photosensitive recording medium cartridge is inserted into the loading slot. Here, the unlocking mechanism may be allowed to move in the horizontal direction in response to the output of the end detecting sensor.

In the recording and reproducing apparatus for a photosensitive recording medium, the shutter may have a bent portion, which is bent toward the cartridge body, at an outer circumferential edge of the shutter and the cartridge body may have a protruded portion formed at a position corresponding to the outer circumferential edge.

In the recording and reproducing apparatus for a photosensitive recording medium, the bent portion may be formed at an end of the outer circumferential edge close to the opening position of the shutter.

In the recording and reproducing apparatus for a photosensitive recording medium, the shutter may have a first light shielding plate portion sliding so as to open and close the opening, a second light shielding plate portion rising vertically from an end of the first light shielding plate portion close to the opening position of the shutter, and a third light shielding plate portion rising vertically from the second light shielding plate portion in a direction in which the shutter is closed. Here, the cartridge body may be provided with a protrusion which is interposed between the first light shielding plate portion and the third light shielding plate portion when the shutter is at the closing position.

In the recording and reproducing apparatus for a photosensitive recording medium, the shutter may have a first light shielding plate portion sliding so as to open and close the opening and a second light shielding plate portion rising vertically from an end of the first light shielding portion close to the opening position of the shutter. Here, the protruded portion may have a protrusion top surface which is provided so as to be opposed to the first light shielding plate portion when the shutter is at the closing position and a protrusion side surface which is provided so as to be opposed to the second light shielding plate portion when the shutter is at the closing position.

In the recording and reproducing apparatus for a photosensitive recording medium, the shutter may have a first light shielding plate portion sliding so as to open and close the opening, a second light shielding plate portion rising vertically from an end of the first light shielding plate portion close to the opening position of the shutter, and a third light shielding plate portion rising vertically from the second light shielding plate portion in a direction in which the shutter is opened. Here, the cartridge body may have a protrusion top surface which is provided so as to be opposed to the first light shielding plate portion when the shutter is at the closing position, a protrusion side surface opposed to the second light shielding plate portion, and a shutter sliding surface offset inwardly in the protrusion top surface and provided so as to be opposed to the third light shielding plate portion when the shutter is at the closing position.

In the recording and reproducing apparatus for a photosensitive recording medium, an inner surface of the cartridge body opposed to the photosensitive recording medium and an outer surface opposed to the shutter may be matted or embossed with a surface roughness Ra of 5 to 20 μm.

In the recording and reproducing apparatus for a photosensitive recording medium, the cartridge body may include a first shell having a substantially plate shape and a second shell welded to the first shell to overlap with each other, the first shell and the second shell may be made of an equal or similar thermoplastic material, and the other components including the shutter may be made of a material different from that of the first shell and the second shell.

In the recording and reproducing apparatus for a photosensitive recording medium, 0.01 weight % to 5.00 weight % of a light shielding material may be added to a plastic used for forming each of the first shell, the second shell, and the shutter.

In the recording and reproducing apparatus for a photosensitive recording medium, 0.01 weight % to 2.00 weight % of carbon black may be added to a plastic used for forming each of the first shell, the second shell, and the shutter.

In the recording and reproducing apparatus for a photosensitive recording medium, 0.1 weight % to 5.0 weight % of a silicon-based lubricant may be added to a plastic used for forming each of the first shell, the second shell, and the shutter.

In another aspect of the invention, a holographic recording medium cartridge as the photosensitive recording medium is received in the photosensitive recording medium cartridge.

In the recording and reproducing apparatus for a photosensitive recording medium according to the second aspect of the invention, it is possible to obtain a recording and reproducing apparatus for a photosensitive recording medium in which a photosensitive recording medium is received in a cartridge which is shielded from light with an erroneous opening preventing countermeasure and in which the time until a recording or reproducing operation can be performed after the cartridge is inserted into the light-shielded recording and reproducing apparatus can be reduced.

In order to accomplish the second task, according to a third aspect of the invention, there is provided a recording and reproducing apparatus for a photosensitive recording medium, the apparatus comprising: a case having a loading slot, which a photosensitive recording medium cartridge can be inserted into, and an inner space shielded from the outside, the photosensitive recording medium cartridge having a cartridge body rotatably receiving the photosensitive recording medium and having an opening for exposing a central portion and a recording surface of the photosensitive recording medium to the outside, a shutter fitted to the outside of the cartridge body and disposed to be movable between a closing position where the opening is closed and an opening position where the opening is opened, and a locking mechanism for locking the shutter at the closing position; an loading slot shutter which is disposed in the case so as to open and close the loading slot and which shields the loading slot from the outside when the loading slot is closed; an unlocking mechanism which is disposed in the case and which is for unlocking a locking member being movable between a first locking position for blocking movement of the shutter to the opening position and a first unlocking position for permitting the movement of the shutter to the opening position; and a shutter opening mechanism which is disposed in the case and which is for opening the shutter of the photosensitive recording medium cartridge, wherein the locking member includes a through hole formed through a cartridge shell disposed in the vicinity of a corner at a leading end in a loading direction of the photosensitive recording medium cartridge and a sliding member passing right below the through hole and sliding toward a rear end in the loading direction from the leading end in the loading direction of the cartridge, wherein a convex portion engaging with a concave portion formed in the shutter at the time of non-use is formed at a leading end of the sliding member in the loading direction of the cartridge and a small hole is formed in the surface opposed to the through hole in the vicinity of a side of a leading end of the through hole in the loading direction of the cartridge, wherein the unlocking mechanism includes an arm, which is rotatably disposed at a leading end of the case in the loading direction of the cartridge and which extends to the rear end in the loading direction therefrom, and an insertion member, which is fitted to an end of the arm and which can move on the cartridge shell to be inserted into the small hole, wherein immediately before the leading end of the photosensitive recording medium cartridge is inserted into the loading slot and then reaches a stop position of the cartridge, the insertion member of the unlocking mechanism enters the small hole of the sliding member from the through hole of the cartridge and the insertion member allows the sliding member to slide toward the rear end in the loading direction of the cartridge by means of an additional insertion of the leading end of the photosensitive recording medium cartridge, whereby the convex portion of the sliding member engaging with the concave portion of the shutter is released from the engagement to be unlocked, and wherein the shutter opening mechanism opens the shutter of the photosensitive recording medium cartridge after checking the shielding of light in the case.

In the recording and reproducing apparatus for a photosensitive recording medium according to the third aspect, an illumination sensor may be disposed in the case and a motor of the shutter opening mechanism may be driven to rotate on the basis of an output of the illumination sensor.

In the recording and reproducing apparatus for a photosensitive recording medium, the insertion member may be a roller and the through hole formed through the cartridge shell and the small hole of the sliding member may have a smooth slope inclined to the rear ends from the leading ends of the through hole and the small hole in the loading direction of the cartridge.

In the recording and reproducing apparatus for a photosensitive recording medium, the shutter may have a bent portion, which is bent toward the cartridge body, at an outer circumferential edge of the shutter and the cartridge body may have a protruded portion formed at a position corresponding to the outer circumferential edge.

In the recording and reproducing apparatus for a photosensitive recording medium, the bent portion may be formed at an end of the outer circumferential edge close to the opening position of the shutter.

In the recording and reproducing apparatus for a photosensitive recording medium, the shutter may have a first light shielding plate portion sliding so as to open and close the opening, a second light shielding plate portion rising vertically from an end of the first light shielding plate portion close to the opening position of the shutter, and a third light shielding plate portion rising vertically from the second light shielding plate portion in a direction in which the shutter is closed. Here, the cartridge body may be provided with a protrusion which is interposed between the first light shielding plate portion and the third light shielding plate portion when the shutter is at the closing position.

In the recording and reproducing apparatus for a photosensitive recording medium, the shutter may have a first light shielding plate portion sliding so as to open and close the opening and a second light shielding plate portion rising vertically from an end of the first light shielding portion close to the opening position of the shutter. Here, the protruded portion may have a protrusion top surface which is provided so as to be opposed to the first light shielding plate portion when the shutter is at the closing position and a protrusion side surface which is provided so as to be opposed to the second light shielding plate portion when the shutter is at the closing position.

In the recording and reproducing apparatus for a photosensitive recording medium, the shutter may have a first light shielding plate portion sliding so as to open and close the opening, a second light shielding plate portion rising vertically from an end of the first light shielding plate portion close to the opening position of the shutter, and a third light shielding plate portion rising vertically from the second light shielding plate portion in a direction in which the shutter is opened. Here, the cartridge body may have a protrusion top surface which is provided so as to be opposed to the first light shielding plate portion when the shutter is at the closing position, a protrusion side surface which is provided so as to be opposed to the second light shielding plate portion when the shutter is at the closing position, and a shutter sliding surface offset inwardly in the protrusion top surface and provided so as to be opposed to the third light shielding plate portion when the shutter is at the closing position.

In the recording and reproducing apparatus for a photosensitive recording medium, an inner surface of the cartridge body opposed to the photosensitive recording medium and an outer surface opposed to the shutter may be matted or embossed with a surface roughness Ra of 5 to 20 cm.

In the recording and reproducing apparatus for a photosensitive recording medium, the cartridge body may include a first shell having a substantially plate shape and a second shell welded to the first shell to overlap with each other, the first shell and the second shell may be made of an equal or similar thermoplastic material, and the other components including the shutter may be made of a material different from that of the first shell and the second shell.

In the recording and reproducing apparatus for a photosensitive recording medium, 0.01 weight % to 5.00 weight % of a light shielding material may be added to a plastic used for forming each of the first shell, the second shell, and the shutter.

In the recording and reproducing apparatus for a photosensitive recording medium, 0.01 weight % to 2.00 weight % of carbon black may be added to a plastic used for forming each of the first shell, the second shell, and the shutter.

In the recording and reproducing apparatus for a photosensitive recording medium, 0.1 weight % to 5.0 weight % of a silicon-based lubricant may be added to a plastic used for forming each of the first shell, the second shell, and the shutter.

In the recording and reproducing apparatus for a photosensitive recording medium, a holographic recording medium cartridge as the photosensitive recording medium is received in the photosensitive recording medium cartridge.

In the recording and reproducing apparatus for a photosensitive recording medium according to the third aspect of the invention, it is possible to obtain a recording and reproducing apparatus which can reduce the time until a recording or reproducing operation can be performed after the cartridge is inserted into the light-shielded recording and reproducing apparatus and which is not erroneously opened.

### BRIEF DESCRIPTION OF THE DRAWINGS

FIG. 1 is a perspective view illustrating a configuration of a recording and reproducing apparatus according to first and second embodiments of the invention.

FIG. 2 is a diagram schematically illustrating the recording and reproducing apparatus.

FIG. 3A is a flowchart illustrating a flow of opening a shutter of a photosensitive recording medium cartridge according to the first embodiment of the invention.

FIG. 3B is a flowchart illustrating a flow of opening a shutter of a photosensitive recording medium cartridge according to the second embodiment of the invention.

FIG. 4 is an exploded perspective view illustrating a configuration of a locking mechanism.

FIG. 5 (FIGS. 5A, 5B and 5C) is a diagram illustrating an operation of the locking mechanism shown in FIG. 4.

FIG. 6 is a flowchart illustrating an operation of checking an illumination in a case of the recording and reproducing apparatus.

FIG. 7 is an exterior perspective view illustrating an outer shape of a cartridge.

FIG. 8 is an exterior perspective view illustrating the opposite side of the cartridge.

FIG. 9 is an exterior perspective view illustrating a state where the shutter of the cartridge is opened.

FIG. 10 is an exploded perspective view illustrating a configuration of the cartridge.

FIG. 11 is a cross-sectional view taken along arrow VI-VI of FIG. 10.

FIG. 12 is a cross-sectional view taken along arrow VII-VII of FIG. 10.

FIG. 13 (FIGS. 13A, 13B and 13C) is a cross-sectional view taken along a loading direction of the cartridge, where FIG. 13A is an entire view, FIG. 13B is an enlarged view of a front edge in FIG. 13A, and FIG. 13C is an enlarged view of a rear edge in FIG. 13A.

FIG. 14 (FIGS. 14A and 14B) is a cross-sectional view taken along a direction perpendicular to the loading direction of the cartridge, where FIG. 14A is a cross-sectional view illustrating a state where the shutter is closed and FIG. 14B is a cross-sectional view illustrating a state where the shutter is opened.

FIG. 15 is an enlarged view illustrating a part surrounded with a circle X in FIG. 14.

FIG. 16 is an enlarged view illustrating a part surrounded with a circle XI in FIG. 14.

FIG. 17 is a flowchart illustrating a flow of opening a shutter of a photosensitive recording medium cartridge in a known apparatus.

FIG. 18 (FIGS. 18(1) and 18(2)) is a perspective view illustrating an unlocking mechanism of a recording and reproducing apparatus according to a third embodiment of the invention, which is shown with the lapses of time (1) and (2).

FIG. 19 (FIGS. 19(3) and 19(4)) is a diagram illustrating the unlocking mechanism with the lapses of time (3) and (4) successive to FIG. 18.

FIG. 20 (FIGS. 20(5) and 20(6)) is a diagram illustrating the unlocking mechanism with the lapses of time (5) and (6) successive to FIG. 19.

FIG. 21 is a perspective view illustrating a configuration of the recording and reproducing apparatus according to the third embodiment of the invention.

FIG. 22 is a diagram schematically illustrating a configuration of a recording and reproducing apparatus.

### DETAILED DESCRIPTION OF THE INVENTION

Hereinafter, first and second embodiments of the invention will be described in detail with reference to the drawings.

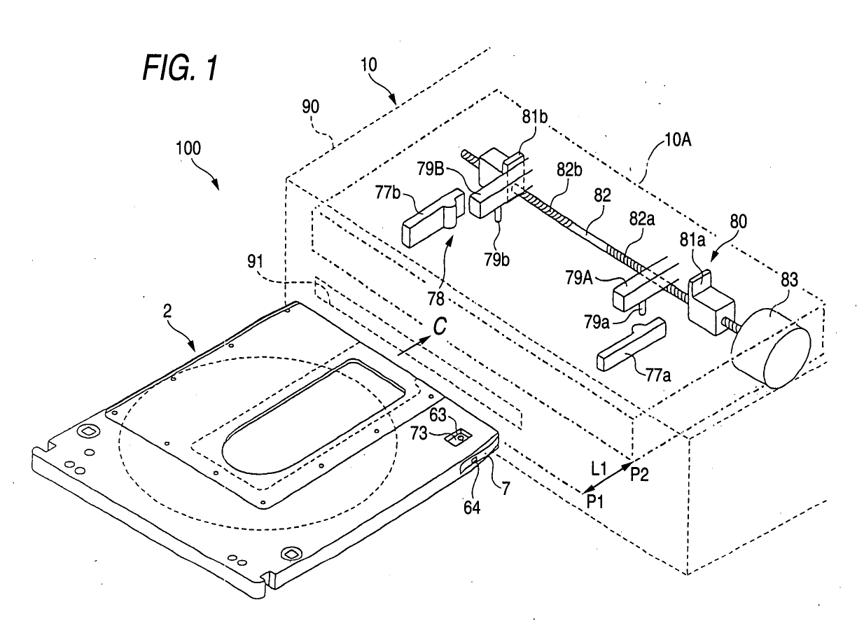

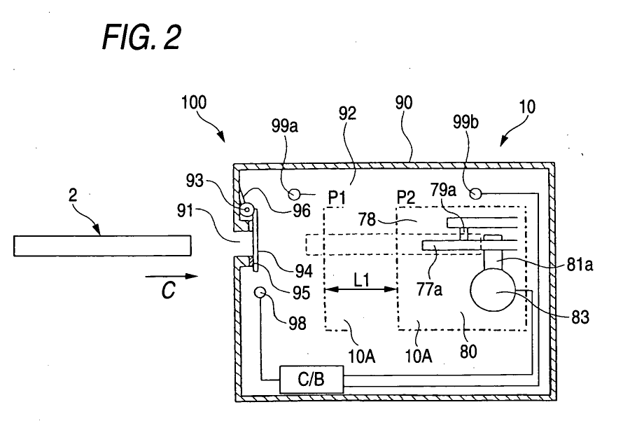

FIG. 1 is a perspective view illustrating a configuration of a recording and reproducing apparatus according to an exemplary embodiment of the invention and FIG. 2 is a diagram schematically illustrating a configuration of the recording and reproducing apparatus. As shown in FIGS. 1 and 2, a recording and reproducing apparatus 10 loading a cartridge 2 therein for use includes a case 90 having a loading slot 91 into which the cartridge 2 can be loaded and an inner space 92 shielded from external light. The loading slot 91 is opened and closed by a loading slot shutter 94 disposed inside the case 90 to be rotatable about a pin 93. The loading slot shutter 94 engages with an end of a twist coil spring 96 and is thus biased in a closing direction of the loading slot shutter 94. A light shielding member 95 is bonded to the entire opening circumference of the loading slot 91 and shields the loading slot 91 from external light in cooperation with the loading slot shutter 94 when the loading slot shutter 94 is closed.

The unlocking mechanism 78 to be described later and the shutter opening mechanism 80 to be described later are built in the case 90. The unlocking mechanism 78 includes a pair of positioning members 77a and 77b as a second unlocking member engaging with a second locking member 64 (FIG. 1) for operation and a pair of engagement pins 79a and 79b as a first unlocking member engaging with a first locking member 63.

The pair of positioning members 77a and 77b protrude toward the loading slot 91 so as to engage with positioning grooves 7 and 8 in both side surfaces of the cartridge 2 inserted from the loading slot 91 in the direction of arrow C. The pair of positioning members 77a and 77b engages with the positioning grooves 7 and 8 to position the cartridge 2 in a loading direction of the cartridge 2 and a direction perpendicular to the loading direction. The pair of positioning members 77a and 77b are movable forwardly by a stroke L1 in the case 90 according to the invention.

The pair of engagement pins 79a and 79b are disposed to protrude downwardly from the pair of arms 79A and 79B fixed to the case 90 and are inserted into operating holes 63d of the first locking member 63 (FIG. 1) from passages 72 and 73 of the cartridge 2 to be loaded. Since a recording operation can be performed to both surfaces of the recording disk 4, the cartridge 2 is loaded into the recording and reproducing apparatus 10 so that an A surface 2a and a B surface 2b are directed upwardly. However, when the loading surface is varied, the position of the locking mechanism 27 is inverted horizontally. Accordingly, the engagement pin 79b for an inverted loading operation is provided so as to engage with the operating hole 63d even when the cartridge 2 is inverted and loaded.

The pair of engagement pins 79a and 79b is disposed to protrude from and retreat to the arms 79A and 79B and is biased downwardly by a spring not shown. Accordingly, when one engagement pin engages with the operating hole 63d, the other engagement pin enters the arm 79 at the time of coming in contact with the cartridge 2, thereby causing no interference. The arms 79A and 79B can move forwardly by a stroke L1 in the case 90 according to the invention.

The shutter opening mechanism 80 includes a pair of operating pieces 81a and 81b coming in contact with the outsides of operating portions 56d of the sliding member 56 and a lead screw 82 in which a right screw 82a and a left screw 82b are formed at both ends thereof, respectively. The operating piece 81a is screwed to the right screw 82a of the lead screw 82 and the operating piece 81b is screwed to the left screw 82b. A rotation shaft of a driving motor 83 is fixed to one end of the lead screw 82 to allow the lead screw 82 to rotate in a clockwise or counterclockwise direction.

When the lead screw 82 rotate in the counterclockwise direction, the operating pieces 81a and 81b move close to each other and pressurizes the pressure portions 56d, thereby allowing the shutter 13 to slide to an opening position. Two operating pieces 81a and 81b are provided so as to cope with the inverted loading of the cartridge 2. The shutter opening mechanism 80 can move forwardly by a stroke L1 in the case 90 according to the invention.

An illumination sensor 98 (FIG. 2) for detecting brightness in the case 90, a first cartridge sensor (end detecting sensor) 99a (FIG. 2) for detecting an end of the cartridge 2 when it is inserted from the loading slot 91, and a second cartridge sensor 99b (FIG. 2) for detecting that the cartridge 2 reaches a predetermined position (recording and reproducing position) are disposed in the case 90. The first cartridge sensor 99a and the second cartridge sensor 99b (FIG. 2) can be simply embodied by a photo coupler or a limit switch. The illumination sensor 98 may be a shutter opening and closing detecting sensor (not shown) for detecting that the loading slot shutter 94 is closed.

The whole unlocking mechanism 10A can move forwardly by the stroke L1 in the case 90 according-to the invention. Since the whole unlocking mechanism 10A moves forwardly by the stroke 11, the second unlocking members 77a and 77b used as the pair of positioning members fixed thereto, the first unlocking members 79a and 79b used as the arms, and the shutter opening mechanism 80 move forwardly and horizontally in the case. The known apparatus is different from the invention, in that there is no structure for allowing the whole unlocking mechanism to move forwardly by the stroke L1 and the positioning members 77a and 77b, the arms 79a and 79b, and the shutter opening mechanism 80 are fixed directly to the case 90.

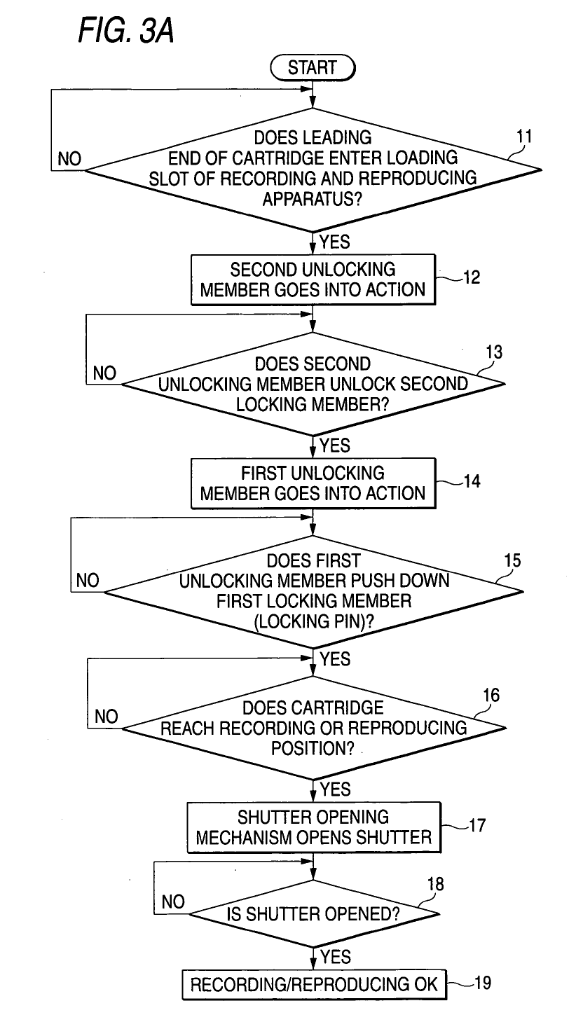

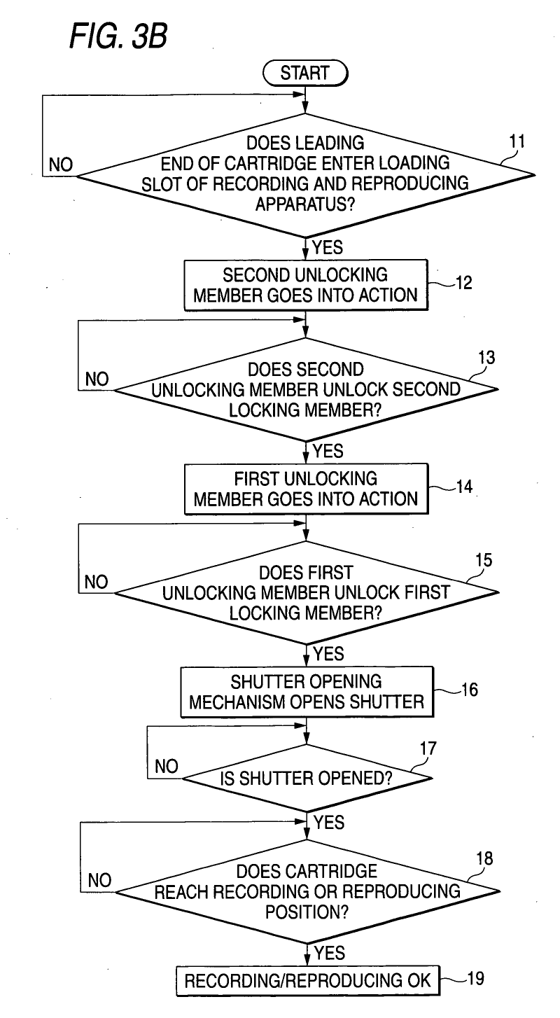

Next, a flow until a recording or reproducing operation is performed to a cartridge after the cartridge is loaded into the recording and reproducing apparatus according to the first embodiment of the invention will be described with reference to the flowchart shown in FIG. 3.

In the figure, when the leading end of the cartridge 2 is inserted into the loading slot 91 (FIGS. 1 and 2) of the recording and reproducing apparatus (S11), the first cartridge sensor 99a (FIG. 2) detects the insertion and the whole unlocking mechanism 10A moves forwardly to a forward position P1 (FIGS. 1 and 2) by the stroke L1. Accordingly, the second unlocking member goes into action (S12) and the second locking member 64 (FIG. 1) of the cartridge 2 in the figure is unlocked (S13). When the second locking member 64 (FIG. 1) is unlocked, the first unlocking member is allowed to go into action (S14) and thus the first locking member 63 (FIG. 1) is unlocked (S15). This series of operations are performed during a retreating period from the front end position P1 to the rear end position (recording and reproducing position) P2 of the whole unlocking mechanism 10A. Accordingly, when the whole unlocking mechanism 10A reaches the rear end position (recording and reproducing position) P2, the first locking member 63 is already unlocked and thus the recording or reproducing operation can be performed right when the shutter is opened (S16) (On the contrary, in the known apparatus, since the cartridge 2 is unlocked when it reaches the recording and reproducing position P2, the recording or reproducing operation is performed lately.)

In the recording and reproducing apparatus according to the first embodiment of the invention, the unlocking operation of the photosensitive recording medium cartridge is performed during the movement. Accordingly, when the photosensitive recording medium cartridge 2 reaches the recording and reproducing position, the recording or reproducing operation can be performed rapidly only by opening the shutter.

Next, a flow until a recording or reproducing operation is performed to a cartridge after the cartridge is loaded into the recording and reproducing apparatus according to the second embodiment of the invention will be described with reference to the flowchart shown in FIG. 3.

In the figure, when the leading end of the cartridge 2 is inserted into the loading slot 91 (FIGS. 1 and 2) of the recording and reproducing apparatus (S11), the first cartridge sensor 99a (FIG. 2) detects the insertion and the whole unlocking mechanism 10A moves forwardly to a forward position P1 (FIGS. 1 and 2) by the stroke L1. Accordingly, the second unlocking member goes into action (S12) and the second locking member 64 (FIG. 1) of the cartridge 2 in the figure is unlocked (S13). When the second locking member 64 (FIG. 1) is unlocked, the first unlocking member is allowed to go into action (S14) and thus the first locking member 63 (FIG. 1) is unlocked (S15). When the first locking member 63 (FIG. 1) is unlocked, the shutter is opened (S16) and the cartridge reaches a predetermined position (S18) in the state where the shutter is completely opened (S17).

Accordingly, the cartridge 2 is in a state where the recording or reproducing operation can be performed thereto.

According to the second embodiment of the invention, since the unlocking and shutter opening operations are performed during a retreating period from the front end position P1 to the rear end position (recording and reproducing position) P2. Accordingly, when the cartridge reaches the rear end position (recording and reproducing position) P2, the shutter is already opened and thus the recording or reproducing operation can be performed thereto (On the contrary, in the known apparatus, since the cartridge 2 is unlocked when it reaches the recording and reproducing position P2, the recording or reproducing operation is performed lately.)

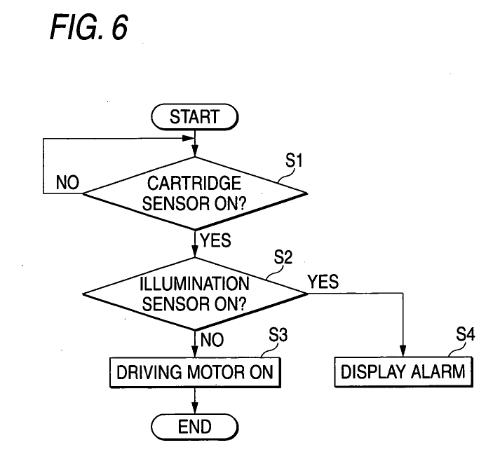

In a modified example, the illumination in the case in FIG. 6 may be checked before the step (S16) of opening the shutter. In this case, when the illumination is lower than or equal to a reference value, the shutter opening operation is performed in step S16 and when the illumination is higher than the reference value, an alarm may be displayed without opening the shutter.

In the recording and reproducing apparatus according to the second embodiment of the invention, the unlocking operation of the photosensitive recording medium cartridge and the shutter opening operation are performed during the movement thereof by moving the mechanisms. Accordingly, when the photosensitive recording medium cartridge 2 reaches the recording and reproducing position, the recording or reproducing operation can be performed rapidly only by opening the shutter.

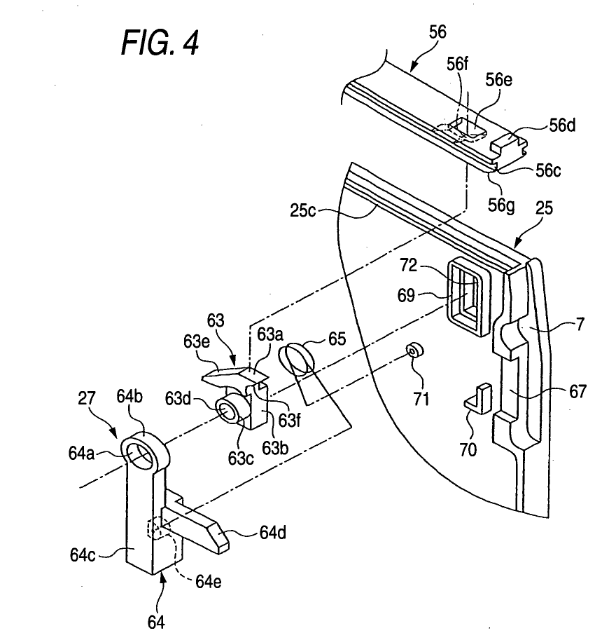

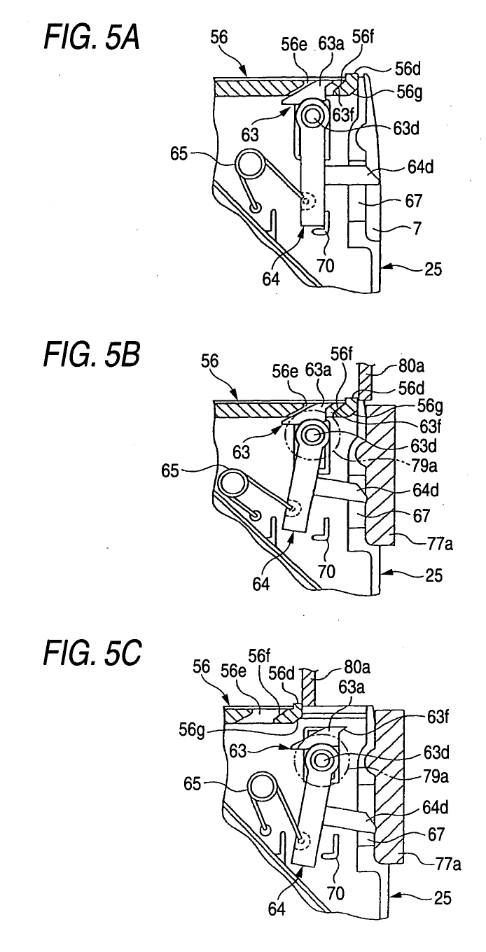

Now, the locking mechanism will be described in detail with reference to FIGS. 4 and 5.

FIG. 4 is an exploded perspective view illustrating a configuration of the locking mechanism and FIG. 5 is a diagram illustrating operations of the locking mechanism shown in FIG. 4. As shown in FIG. 4, the locking mechanism 27 includes a first locking member 63 locking the shutter 13 at a closing position, a second locking member 64 locking the movement of the first locking member 63, and a locking spring 65 biasing the second locking member 64 in the counterclockwise direction and the upward direction in the figure.

The first locking member 63 includes a locking pawl 63a engaging with a lockable groove 56e formed in the sliding member 56 to lock the shutter 13 at the closing position, a rectangular sliding portion 63b integrally formed with the locking pawl 63a, a cylindrical boss 63c formed on the surface of the sliding portion 63b opposed to the second shell 26, and an operating hole 63d formed through the boss 63c and the sliding portion 63b.

In the left side of the locking pawl 63a in the figure, a slope 63e for guiding the engagement with the lockable groove 56e when the shutter 13 moves from the opening position and the closing position is formed substantially parallel to an engagement slope 56f of the sliding member 56. In the right side of the locking pawl 63a in the figure, a hook portion 63f which is a slope substantially parallel to the engagement slope 56f of the lockable groove 56e is formed. When the sliding member 56 moves to the left side in the figure (in a direction in which the shutter 13 is opened), the hook portion 63f comes in contact with the engagement slope 56f, thereby surely blocking the movement thereof.

The second locking member 64 includes a link portion 64b having a hole 64a which are rotatably inserted onto the outer circumference of the boss 63c of the first locking member 63, a rotation portion 64c formed integrally with the link portion 64b so as to rotate about the boss 63c, a pressed piece 64d vertically rising from the side surface of the rotation portion 64c, and a spring fixing portion 64e to which one end of the locking spring 65 is fixed.

The first locking member 63 moves between a first locking position where the hook portion 63f of the locking pawl 63a comes in contact with the engagement slope 56f of the lockable groove 56e of the sliding member 56 as shown in FIG. 5A and a second unlocking position where the first locking member slides downwardly and releases the engagement with the lockable groove 56e as shown in FIG. 5C.

At the first locking position shown in FIG. 5A, the right end of the hook portion 63f of the locking pawl 63a and the left end of the engagement slope 56f of the lockable groove 56e are disposed in the same vertical or horizontal line with a slight gap therebetween. In other words, in this state, the hook portion 63f and the engagement slope 56f do not engage with each other and thus the first locking member 63 can move downwardly.

However, when the sliding member 56 moves slightly to the left side in the figure, the engagement slope 56f surely engages with the hook portion 63f, thereby suppressing the movement of the sliding member 56. When the sliding member 56 moves to the left side, the shutter 13 also moves in the opening direction. However, since the distance in which the engagement slope 56f moves until engaging with the hook portion 63f is still smaller than the amount of overlap between the cartridge body 11 and the shutter 13 in the vicinity of inner openings 18 and 19, the inner openings 18 and 19 are not opened.

The second locking member 64 moves between a second locking position where it is biased in a vertical state by the locking spring 65 to allow the pressed piece 64d to protrude from a cut 67 in the positioning groove 7 as shown in FIG. 5A and a second unlocking position where it rotates in the clockwise direction in the figure as shown in FIG. 5B.

In the inner surface of the first shell 25, a rectangular sliding frame 69 into which the sliding portion 63b of the first locking member 63 is inverted to be slidable in the vertical direction, a regulating piece 70 receiving the side surface and the bottom surface of the rotation portion 64c of the second locking member and regulating the rotation in the counterclockwise direction and the sliding in the downward direction, and a boss 71 to which the other end of the locking spring 65 is fixed are formed. An opening 72 exposing the operating hole 63d of the first locking member 63 from the outer surface of the first shell 25 is formed in the sliding frame 69. An opening 73 exposing the operating hole 63d similarly is formed in the second shell 26 at a position opposed to the opening 72.

FIG. 5A shows a state of the second locking mechanism 27 of the cartridge 2 in non-use. Since the second locking member 64 is biased upwardly by the locking spring 65, the locking pawl 63a of the first locking member 63 is inserted into the lockable groove 56e of the sliding member 56. Accordingly, when it is intended to allow the shutter 13 to slide from the closing position to the opening position, the engagement slope 56f of the lockable groove 56e and the hook portion 63f of the locking pawl 63a come in contact with each other and thus the shutter 13 does not slide. The slope direction of the engagement slope 56f and the hook portion 63f is set to come in further contact with each other when the sliding member 56 moves in a direction in which the shutter 13 is opened. Accordingly, the movement of the sliding member 56 is surely prevented.

Even when it is intended to allow the shutter to slide by inserting a rod into the operating hole 63d of the first locking member 63 from the openings 72 and 73 disposed in the first shell 25 and the second shell 26, the bottom of the second locking member 64 comes in contact with the regulating piece 70 and thus the locked state is not released.

When the cartridge 2 is loaded into the recording and reproducing apparatus (holographic recording apparatus) 10 through the loading slot 91, the position member 77a fixed to the recording and reproducing apparatus 10 is inserted into the position groove 7 as shown in FIG. 5B to position the cartridge 2 and presses the pressed piece 64d of the second locking member 64 against the biasing force of the locking spring 65. Since the second locking member 64 rotates in the clockwise direction about the link portion 64b and the bottom of the rotation portion 64c is detached from the regulating piece 70, the first locking member 63 can slide downwardly.

When the cartridge 2 is further inserted in the direction of arrow C and the operating hole 63d of the first locking member 63 reaches the position of the engagement pin 79a of the unlocking mechanism 78 fixed to the apparatus, the engagement pin 79a is inserted into the operating hole 63d of the first locking member 63 by means of a spring built in the arm 79. Then, as shown in FIG. 5C, the first locking member 63 moves downwardly in the figure by means of the further insertion of the cartridge 2 and the locking pawl 63a is pulled out of the lockable groove 56e, thereby releasing the engagement. Accordingly, the locking mechanism 27 of the cartridge 2 is unlocked and thus the shutter 13 can be opened and closed.

Referring to FIG. 6, in the first embodiment of the invention, when the cartridge 2 unlocked as described above reaches a predetermined position, the cartridge sensor 99 detects the leading end of the cartridge 2 and is changed to ON, thereby detecting that the cartridge 2 is normally inserted to the predetermined position (S1). At this time, the operating piece 81a of the shutter opening mechanism 80 is disposed outside the operated portion 56d of the sliding member 56.

Subsequently, when the illumination sensor 98 detects the brightness in the case 90 and the detected illumination is lower than or equal to a predetermined value, it is judged that the case 90 is shielded from light (S2) and the lead screw 82 is allowed to rotate in the counterclockwise direction by the driving motor 83 (S3). Accordingly, the operating pieces 81a and 81b screwed to the right screw 82a and the left screw 82b of the lead screw 82 move close to each other and press the operable portion 56d, thereby opening the shutter 13. Then, data are recorded or recorded data are produced by a head not shown while allowing the recording disk 4 to rotate.

When the illumination detected by the illumination sensor 98 is higher than a predetermined value (S2), the recording disk 4 may be exposed to light. Accordingly, without opening the shutter 13, a user is allowed to take notice thereof by displaying an alarm on a display unit (not shown) or discharging the cartridge 2 (S4).

In the second embodiment of the invention, the cartridge 2 unlocked as described above may be subjected to a process of checking the illumination in the case shown in FIG. 6 before opening the shutter.

First, when the cartridge end detecting sensor 99a detects the leading end of the cartridge 2 and is changed to ON and detects that the cartridge 2 is normally inserted into the loading slot (S1), the illumination sensor 98 detects the brightness in the case 90. At this time, the operating piece 81a of the shutter opening mechanism 80 (FIG. 1) is disposed outside of the operable portion 56d of the sliding member 56.

When the illumination in the case 90 is lower than or equal to a predetermined value and thus it is determined that the case 90 is shielded from light (S2), the shutter opening operation is possible. That is, when the locking mechanism 27 of the cartridge 2 is unlocked, the lead screw 82 (FIG. 1) is allowed to rotate in the counterclockwise direction by means of the rotation of the driving motor 83 in the shutter opening operation (S3).

Accordingly, the operating pieces 81a and 81b screwed to the right screw 82a and the left screw 82b of the lead screw 82 move close to each other and press the operable portion 56d, thereby opening the shutter 13.

In this way, when the cartridge 2 reaches a predetermined position, the shutter is in the opened state according to the second embodiment of the invention.

Then, data are recorded or recorded data are produced by a head not shown while allowing the recording disk 4 to rotate.

When the illumination detected by the illumination sensor 98 is higher than a predetermined value (S2), the recording disk 4 may be exposed to light. Accordingly, without opening the shutter 13, a user is allowed to take notice thereof by displaying an alarm on a display unit (not shown) or discharging the cartridge 2 (S4).

In this way, the locking mechanism 27 is unlocked only when the second locking member 64 is allowed to rotate and the first locking member 63 is allowed to slide. Accordingly, it is possible to effectively prevent the shutter 13 from being carelessly opened. Since the locking mechanism 27 is automatically unlocked by inserting the cartridge 2 into the recording and reproducing apparatus 10 and the shutter 13 is opened after the recording and reproducing apparatus 10 is shielded from light, it is possible to surely prevent the exposure of the recording disk 4 to light.

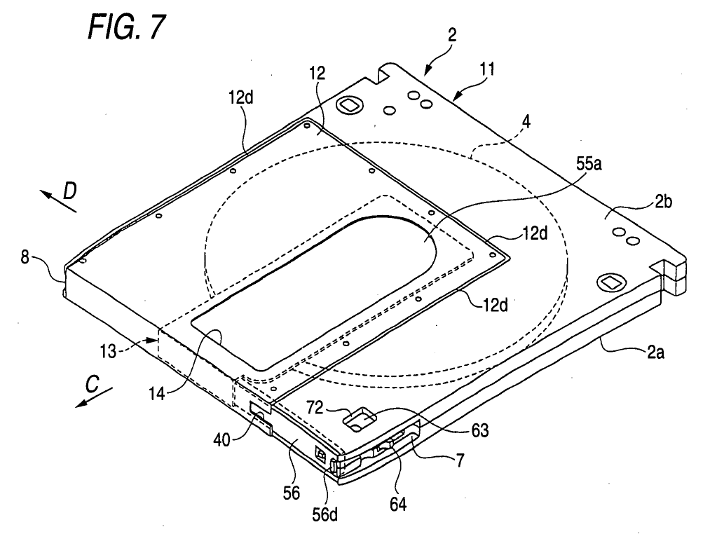

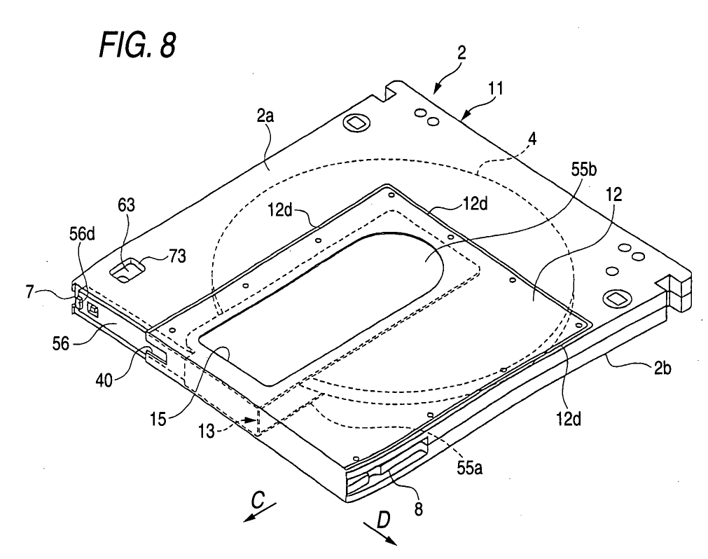

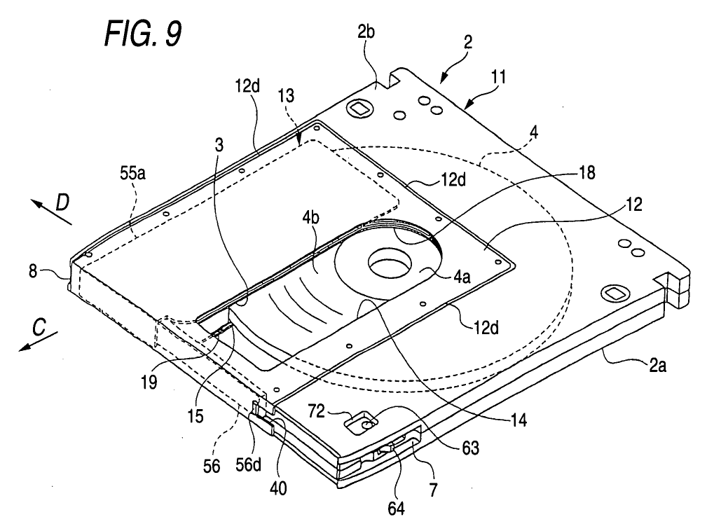

FIGS. 7 to 9 are perspective views illustrating an outer shape of a holographic recording medium cartridge (hereinafter, abbreviated as a cartridge), wherein FIG. 7 is a perspective view illustrating a state where one surface of the cartridge is directed upward, FIG. 8 is a perspective view illustrating a state where the other surface is directed upward, and FIG. 9 is a perspective view illustrating a state where the shutter is located at the opening position and the disk-shaped holographic recording medium (hereinafter, referred to as a recording disk) is rotatably received in a disk receiving portion.

As shown in FIG. 1, since a recording and reproducing system 100 includes the cartridge 2 and the recording and reproducing apparatus 10, the cartridge 2 is now described.

As shown in FIGS. 1 to 9, the cartridge 2 is loaded into the recording and reproducing apparatus 10 such as a holographic recording apparatus using the cartridge in the direction of arrow C. Both side surfaces of the leading end of the cartridge 2 is provided with the positioning grooves 7 (FIG. 1) and 8 (FIG. 7) into which positioning members formed in the recording and reproducing apparatus 10 when the cartridge 2 is loaded into the recording and reproducing apparatus 10 such as the holographic recording apparatus.

The recording disk 4 is a holographic recording disk having a hole formed through the center thereof and a disk shape and holographic recording layers are formed on both surfaces thereof. Data are recorded as interference fringes of laser beams in the holographic recording layers in a multi-layered manner by means of the laser beams in the wavelength band of green 532 nm to blue 405 nm. The cartridge 2 is loaded in the recording and reproducing apparatus (holographic recording apparatus) 10 with any one of an A surface 2a and a B surface 2b directed upward so as to record data on both recording surfaces of the recording disk 4.

The cartridge 2 includes a cartridge body 11 provided with a disk receiving portion 3, a light shielding plate 12 sandwiching the outside of the cartridge body 11, and a shutter 13 fitted between the cartridge body 11 and the light shielding plate 12. Substantially rectangular outer openings 14 and 15 as second openings are formed in the top and bottom surfaces of the light shielding plate 12. The outer openings 14 and 15 are closed by a first shutter 55a and a second shutter 55b when the shutter 13 is at a closing position.

As shown in FIG. 9, when the shutter 13 moves to the opening position in the direction of arrow D, inner openings 18 and 19, which are formed in the cartridge body 11 so as to oppose the outer openings 14 and 15 and have the same shape, are opened along with the outer openings 14 and 15. Accordingly, the central portion 4a and the recording surface 4b of the recording disk 4 received in the disk receiving portion 3 are exposed.

The shutter 13 is biased to the closing position by a built-in shutter spring and is locked at the closing position by the locking mechanism. The locking mechanism is unlocked by inserting the second locking member 64 protruding in the positioning groove 7 into the cartridge 2 and allowing the first locking member 63, which is exposed from the openings 73 and 72 of the A surface 2a and the B surface 2b of the cartridge 2 in that state, to the rear end in the cartridge loading direction. In this way, since the shutter 13 is locked at the closing position by the locking mechanism, which is unlocked only by a two-step operation, the shutter 13 is not opened carelessly.

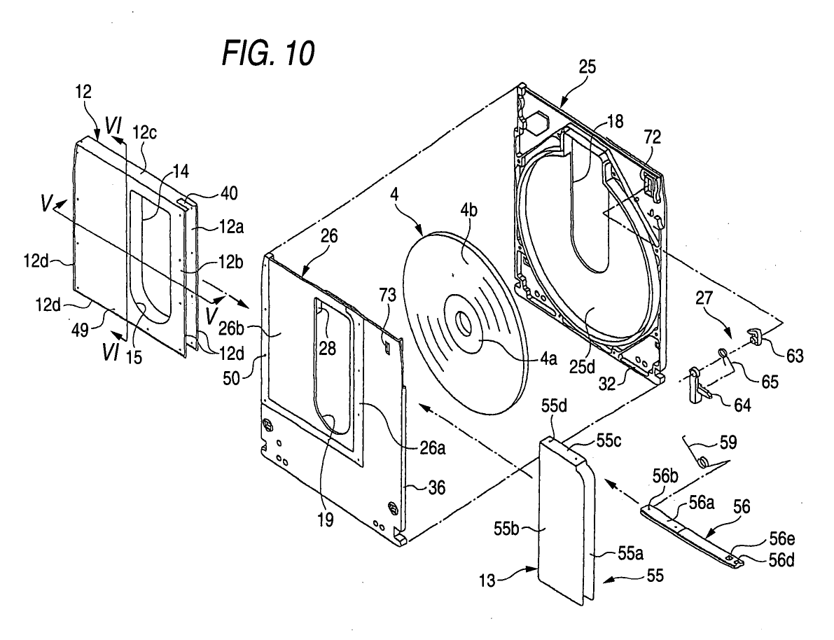

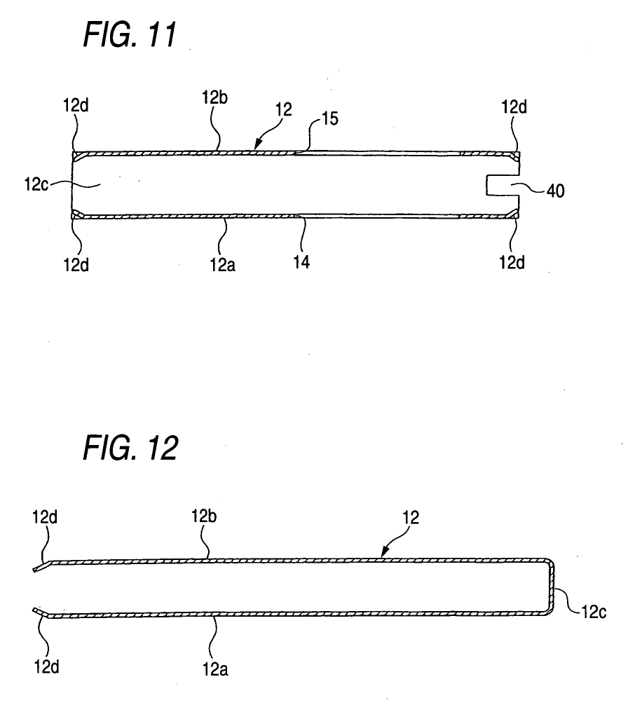

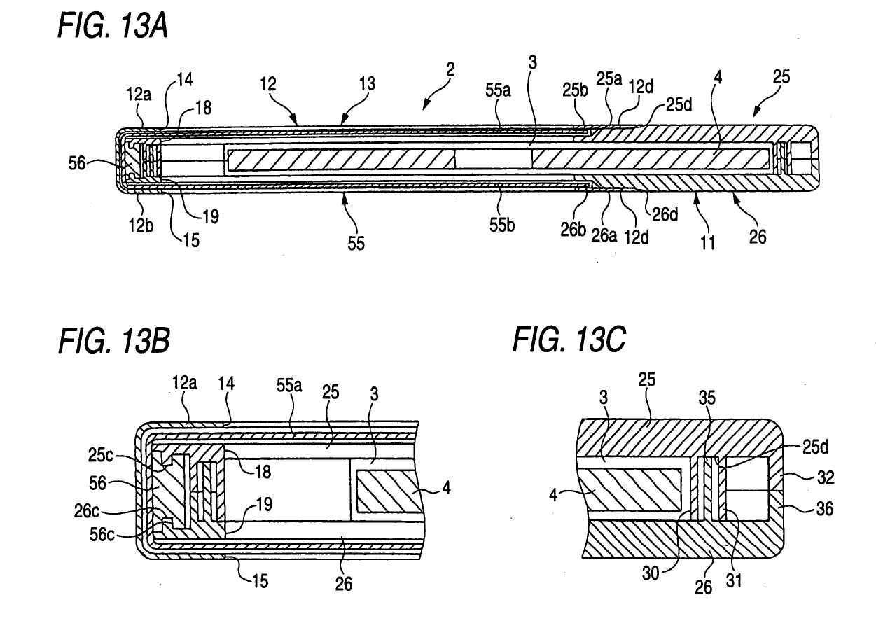

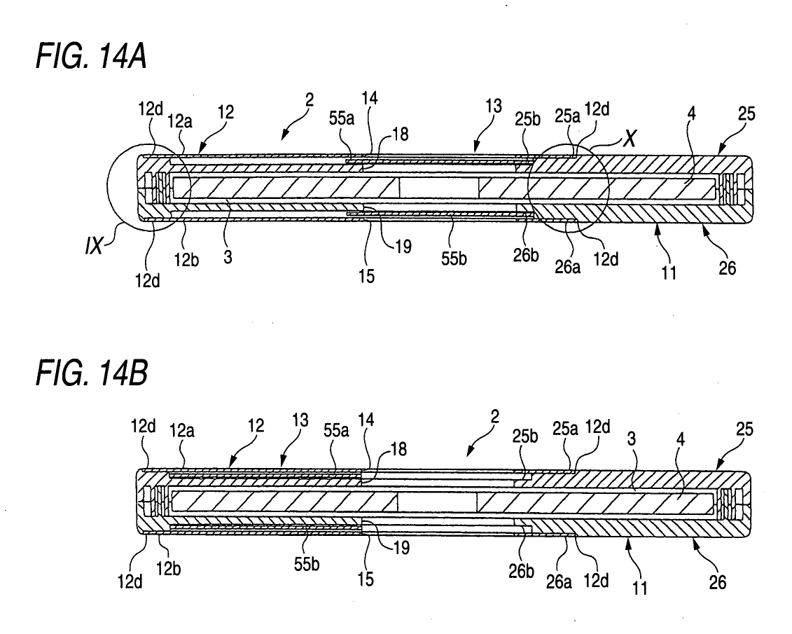

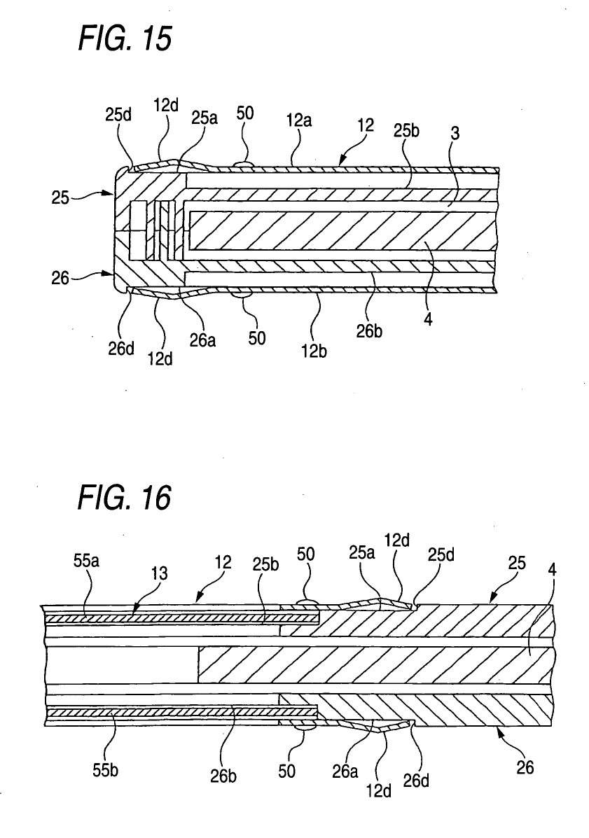

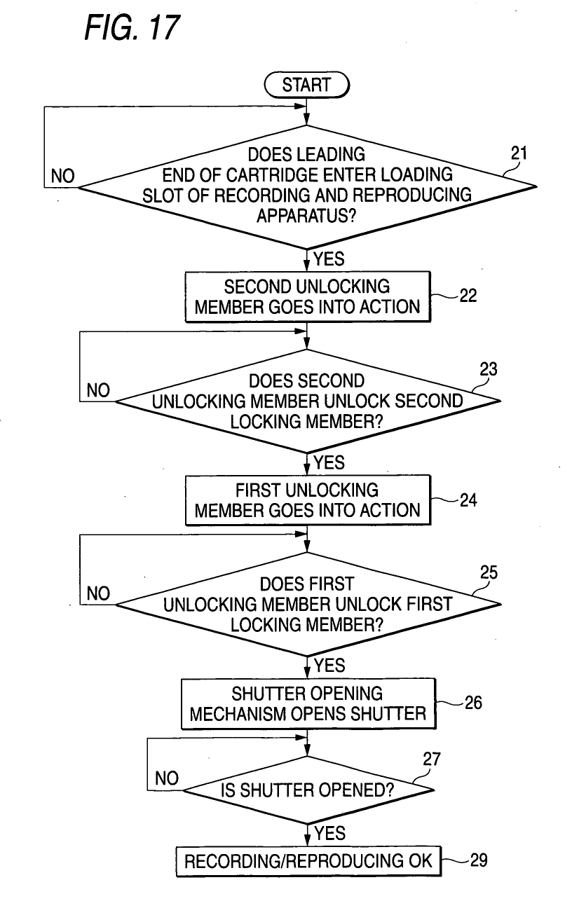

FIG. 10 is an exploded perspective view illustrating a configuration of a cartridge, FIG. 11 is a cross-sectional view taken along arrow VI-VI in FIG. 10, and FIG. 12 is a cross-sectional view taken along arrow VII-VII in FIG. 10. FIG. 13A is a cross-sectional view taken along the loading direction of the cartridge, FIG. 13B is an enlarged view illustrating a leading end portion of FIG. 13A, and FIG. 13C is an enlarged view illustrating a read end portion of FIG. 13A. FIG. 14 is a cross-sectional view taken along a direction perpendicular to the loading direction of the cartridge, where FIG. 14A is a cross-sectional view illustrating a state where the shutter is closed and FIG. 14B is a cross-sectional view illustrating a state where the shutter is opened. FIG. 15 is an enlarged view illustrating a part surrounded with a circle X in FIG. 14 and FIG. 16 is an enlarged view illustrating a part surrounded with a circle XI in FIG. 14.

As shown in FIG. 10, the cartridge body 11 includes a substantially plate-shaped first shell 25, a second shell 26 bonded to the first shell 25, and a locking mechanism 27 which is fitted between the first shell 25 and the second shell 26 so as to lock the shutter 13.

The first shell 25 and the second shell 26 are formed of an equal or similar thermoplastic to which a light shielding material and a lubricant are added by the use of an extrusion molding method. As shown in FIG. 13C which is an enlarged sectional view illustrating the read end portion of the cartridge 2, a first light shielding wall 30 as a protrusion having a diameter larger than the outer diameter of the recording disk 4, a second light shielding wall 31 disposed outside the first light shielding wall 30, and a protrusion 32 disposed in the entire outer circumferential edge are provided on the inner surface of the first shell 25. An inner opening 18 for exposing the central portion 4a and the recording surface 4b of the recording disk 4 is formed inside the first light shielding wall 30.

A third light shielding wall 35 which is a protrusion having a diameter larger than the outer diameter of the recording disk 4 and is interposed between the first light shielding wall 30 and the second light shielding wall 31 of the first shell 25 and a protrusion 36 formed on the entire outer circumferential edge are provided on the inner surface of the second shell 26. An inner opening n19 for exposing the central portion 4a and the recording surface 4b of the recording disk 4 is formed inside the third light shielding wall 35.

When the recording disk 4 is placed inside the third light shielding wall 35 of the second shell 26 and the first shell 25 is placed on the second shell 26, the third light shielding wall 35 is inserted between the first light shielding wall 30 and the second light shielding wall 31 and the end of the third light shielding wall 35 comes in contact with the inner surface 25e of the first shell 25. The disk receiving portion 3 is defined by the light shielding walls 30, 31, and 35, the first shell 25, and the second shell 26. The sidewall of the disk receiving portion 3 has a labyrinth-shaped light shielding structure in which three light shielding walls 30, 31, and 35 are mixed and combined. Accordingly, even when light or dust is invaded through the bonding portion of the first shell 25 and the second shell 26, it does not enter the disk receiving portion 3.

The end of the third light shielding wall 35 of the second shell 26 is fixed to the inner surface 25e of the first shell 25 by means of an ultrasonic welding method. Accordingly, since the first shell 25 and the second shell 26 are strongly bonded to each other, the bonding portion therebetween does not have any gap.

As shown in FIGS. 10 and 13 to 16, stepped portions 25d and 26d having a size slightly larger than that of the light shielding plate 12 and a depth larger than the thickness of the light shielding plate 12 and light-shielding plate fitting surfaces 25a and 26a offset inwardly are formed in the outer surfaces of the first shell 25 and the second shell 26.

The light shielding plate 12 is made of, for example, an aluminum alloy having a light shielding property, a corrosion resistant property, a decorative property, and a processible property and having a small weight and strength. The light shielding plate 12 may be formed of a plastic material. In this case, a plastic material to which a light shielding material and a lubricant are added may be used to secure the light shielding property and sliding property of the shutter 13.

As shown in FIGS. 10 to 12, the light shielding plate 12 is obtained by forming the outer openings 14 and 15 and a cut for making it possible for the shutter 13 to move in a thin plate made of an aluminum alloy and then bending the thin plate to have a substantially ⊃-shaped section. Accordingly, a first plate portion 12a and a second plate portion 12b having the outer openings 14 and 15, respectively, and a third plate portion 12c having the cut 40 and connecting the first plate portion 12a and the second plate portion 12b are provided in the light shielding plate 12.

Incisions are formed in ridge portions between the third plate portion 12c and the first and second plate portions 12a and 12b and intersections between two sides in the loading direction C of the cartridge 2 and one side in the direction perpendicular to the loading direction C and the outer circumferential edges of the first plate portion 12a and the second plate portion 12b are bent in the direction (in other words, a direction directed to the cartridge body 11 when it is fitted into the cartridge body 11) close to each other in a substantially ˆ shape. Accordingly, substantially ˆ-shaped bent portions 12d are formed in the outer circumferential edges of the first plate portion 12a and the second plate portion 12b. It is preferable in view of light shielding performance that the bent portions 12d are formed in three sides of the outer circumferential edges, but the invention is not limited to it.

The light shielding plate 12 is fitted to the light-shielding plate fitting surfaces 25a and 26a of the cartridge body 11, so that the B surface 2b and the A surface 2a of the cartridge body 11 are interposed between the first plate portion 12a and the second plate portion 12b and the front end in the loading direction C of the cartridge body 11 is covered with the third plate portion 12c. Since the light-shielding plate fitting surface 25a and 26a are offset inwardly with a depth larger than the thickness of the light shielding plate 12, the outer surface of the light shielding plate 12 fitted to the cartridge body 11 does not protrude from the surface of the cartridge 2. As shown in FIGS. 13 to 16, the ends of the bent portions 12d of the first plate portion 12a and the second plate portion 12b are opposed to the stepped portions 25d and 26d of the first shell 25 and the second shell 26.

As shown in FIG. 10, small holes 49 are formed with a constant interval in the outer circumferences of the first plate portion 12a and the second plate portion 12b of the light shielding plate 12. In the light-shielding plate fitting surfaces 25a and 26a of the first shell 25 and the second shell 26, pins 50 having a length slightly larger than the thickness of the light shielding plate 12 are integrally formed at positions corresponding to the holes 49 of the light shielding plate 12.

As shown in FIGS. 13 to 16, when the light shielding plate 12 is fitted to the outside (the light-shielding plate fitting surfaces 25a and 26a) of the cartridge body 11, the pins of the first shell 25 and the second shell 26 are inserted into the holes 49 and protrudes from the surface of the light'shielding plate 12. In the light shielding plate 12, the ends of the bent portions 12d are pressed to the light-shielding plate fitting surfaces 25a and 26a and the ends of the pins 50 are crushed by heat, thereby fixing the ends to the cartridge body 11.

Accordingly, the ends of the bent portions 12d of the light shielding plate 12 are opposed to the stepped portions 25d and 26d and are pressed to the light-shielding plate fitting surfaces 25a and 26a by means of an elastic force of the light shielding plate 12 to come in contact therewith without any gap. That is, the outer edges (the ends of the bent portions 12d) of the light shielding plate 12 and the light-shielding plate fitting surfaces 25a and 26a come in close contact with each other without any gap. In addition, since the outer edges of the light shielding plate 12 are covered with the stepped portions 25d and 26d. As a result, even when a gap partially exists due to an error in precision of components, the invasion of light can be surely prevented, thereby surely blocking light.

In addition, as a method of fixing the light shielding plate 12 to the cartridge body 11, an adhesive, a double-sided tape, a screw coupling, and the like may be used. When the light shielding plate 12 is formed of a plastic material, a variety of welding methods may be used.

As shown in FIG. 10, the shutter 13 includes a shutter member 55 obtained by bending a thin plate having a light shielding property in a substantially ⊃ shape and a longitudinal and narrow plate-shaped sliding member 56. The shutter member 55 is made of, for example, an aluminum alloy for the same reason as the light shielding plate 12. The shutter member 55 may be made of a plastic material and may be made of a plastic material to which a light shielding material and a lubricant are added to secure the light shielding property and the slidable property. The sliding member 56 is made of a plastic material to which a light shielding material and a lubricant are added.

The shutter member 55 includes a first shutter 55a interposed between the outer surface of the first shell 25 and the first plate portion 12a of the light shielding plate 12, a second shutter 55b interposed between the outer surface of the second shell 26 and the second plate portion 12b of the light shielding plate 12, and a connection portion 55c which extends from the first shutter 55a and the second shutter 55b and to which the sliding member 56 is fitted.

On the outer surfaces of the first shell 25 and the second shell 26, shutter sliding surfaces 25b and 26b offset inwardly with a depth larger than the thickness of the shutter member 55 are formed inside the light-shielding plate fitting surfaces 25a and 26a. Accordingly, since the shutter 13 can smoothly move between the cartridge body 11 and the light shielding plate 12, it is possible to prevent scraping due to the movement. The shutter sliding surfaces 25b and 26b may be roughened to scatter the incident light. Similarly, the inner surface of the light shielding plate 12 and the inner surface and the outer surface of the shutter 13 may be roughened.

The sliding member 56 is slidably fitted between the first shell 25 and the second shell 26 so that the top surface thereof is exposed from the end surface in the loading direction of the cartridge body 11. The top end of the sliding member 56 is provided with a fitting surface 56a which is fitted to the inner surface of the connection portion 55c of the shutter member 55. For example, two pins 56b are integrally formed on the fitting surface 56a and are inserted into two holes 55d formed in the connection portions 55c, and the tips thereof are crushed by heat, thereby fixing the shutter member 55 and the sliding member 56 to each other. An adhesive or a double-sided tape, or the like may be used for the fixing. When the shutter member 55 is made of a plastic material, a variety of welding methods may be used. A screw fixing method may be used.

As shown in FIGS. 13B and 4, grooves 56c are formed in the side surfaces of the sliding member 56 in the longitudinal direction. Protrusions 35c and 26c formed on the inner surface of the first shell 25 and the second shell 26 at the end in the loading direction are inserted into the grooves 56c. The sliding member 56 can slide without departing from the cartridge body 11 by the use of the grooves 56c and the protrusions 25c and 26c.

An operable portion 56d to be operated at the time of opening the shutter 13 is integrally formed at the other end of the top of the sliding member 56. The operable portion 56d is exposed without being covered with the third plate portion 12c of the light shielding plate 12 by allowing the sliding member 56 to extend in the direction in which the shutter is closed with respect to the shutter member 55. The cut 40 of the third plate portion 12c of the light shielding plate 12 is provided to avoid the interference with the operable portion 56d when the shutter 13 moves to the opening position (see FIG. 9).

The shutter 13 is biased in the closing direction by the shutter spring 59. The shutter spring 59 is formed of, for example, a torsion coil spring and both ends thereof are fixed to the sliding member 56 and the inner surface of the first shell 25.

A lockable groove 56e having a rectangular hole shape is formed in the sliding member 56 in the vicinity of the operable portion 56d. An engagement slope 56f gradually inclined toward the other end (in the direction directed to the operable portion 56d) of the sliding member 56 in the loading direction C of the cartridge 2 is formed in the outer side surface of the lockable groove 56e (see FIG. 5). The corner between the right end surface and the bottom surface of the sliding member 56 in the figure are chamfered substantially parallel to the engagement slope 56f, thereby forming a guide slope 56g.

The ultrasonic welding method has been used for bonding the first shell and the second shell to each other and other welding or fixing methods may be used. For example, when a screw coupling method is used, a light shielding structure may be formed around the screw hole. Each of the second shell and the first shell has been composed of one component, but a plurality of components may be combined. For example, when each shell is composed of two components, it is possible to simplify the mold.

Although the cartridge receiving a recording disk of which both surfaces can be subjected to a recording operation has been described, the invention may be applied to a recording disk of which one surface is subjected to a recording operation. In this case, the opening is formed only one surface and the opening is opened and closed by a shutter. Although the cartridge receiving a holographic recording medium has been described, the invention can be applied to other cartridges receiving a recording medium having a photosensitivity. Although the double locking mechanism has been described as the locking mechanism, the invention is not limited to it.

Hereinafter, a third embodiment of the invention will be described in detail with reference to the drawings.

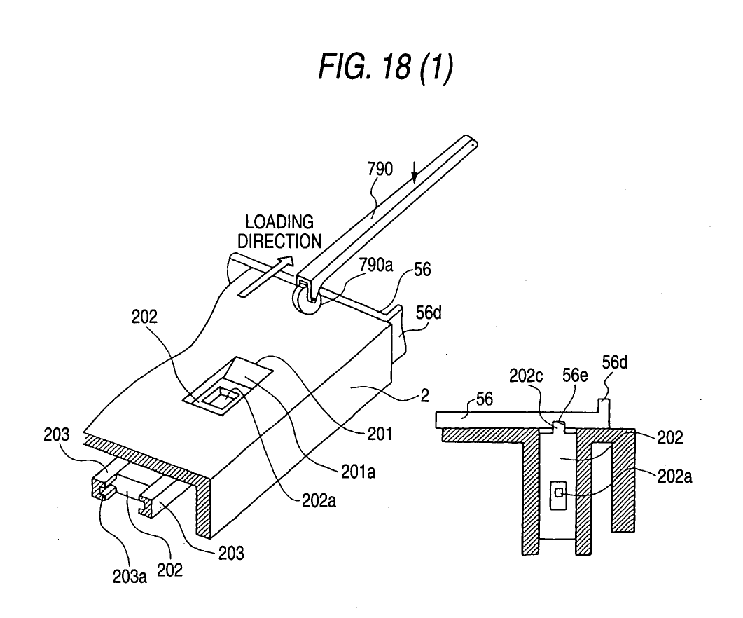

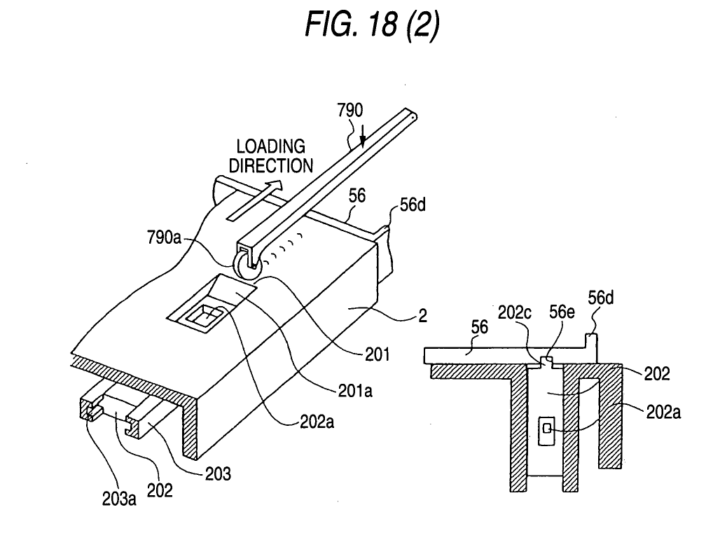

FIGS. 18 to 20 are perspective views illustrating an unlocking mechanism of a recording and reproducing apparatus according to a third embodiment of the invention, where (1) to (6) in the three figures shows operations of the unlocking mechanism with the lapse of time.

<Configuration of Unlocking Mechanism>

In FIG. 18, reference numeral 201 denotes a through hole formed through a cartridge shell provided in the vicinity of the edge of the leading end in the loading direction of the photosensitive recording medium cartridge 2. The through hole 201 is a longitudinal and narrow hole, a smooth slope 201a is formed from the short side of the leading end in the cartridge loading direction to the short side of the rear end, and the short side of the rear end is a vertical surface. Accordingly, even when the cartridge is further inserted, a roller 790a of an unlocking arm does not scramble out of the through hole 201 and when the cartridge is unloaded, the roller 790a can smoothly retreat from the through hole 201.

Here, the roller 790a is exemplified, but the invention is not limited to the roller 790a. For example, if only it can be inserted into the through hole 201, any member may be used (here, comprehensively referred to as “insertion member”).

The sliding member 202 slides right below the through hole 201 from the leading end in the cartridge loading direction to the rear end of the cartridge loading direction. That is, two rails 203 and 203 are disposed parallel to each other at the inside of the cartridge shell from the leading end in the cartridge loading direction to the rear end in the loading direction. Grooves 203a are formed at the centers of the two rails 203 and 203 opposed to each other in the longitudinal direction of the rails 203 and 203.

The sliding member 202 has a longitudinal ruler shape with a rectangular section and a small hole 202a is formed in the surface thereof opposed to the through hole 201 in the vicinity of a side of the leading end in the cartridge loading direction.

Convex portions 202b and 202b inserted into the grooves 203a and 203a of the rails 203 and 203 are formed on the surface opposed to the rails 203 and 203. Accordingly, the sliding member 202 can slide in the longitudinal direction between the rails 203 and 203.

A convex portion 202c engaging with a concave portion 56e formed in the shutter 56 at the time of non-use is formed at the leading end in the cartridge loading direction of the sliding member 202.

In the small hole 202a of the sliding member 202, a smooth slope 201a is formed from the short side of the leading end in the cartridge loading direction to the short side of the rear end and the short side of the rear end is a vertical surface. Accordingly, even when the cartridge is further inserted after the roller 790a of the unlocking arm 790 is inserted into the small hole 202a, the roller 790a does not scramble out of the small hole 202a. When the cartridge is unloaded, the roller 790a can smoothly retreat from the small hole 202a. When the cartridge is further inserted after the roller 790a is inserted into the small hole 202a, the sliding member 202 start sliding and when the roller 790a comes in contact with the vertical wall of the through hole 201, the sliding member ends the sliding. By allowing the sliding member 202 to slide to the rear end in the loading direction of the cartridge 2, the convex potion 202c of the sliding member 202 departs from the concave portion 56e formed in the shutter 56 and the shutter is unlocked.

The unlocking mechanism is embodied by the arm 790 having the roller 790a fitted to the leading end thereof. One end (an end having the roller 790a) of the arm 790 is rotatably fitted to the leading end in the cartridge loading direction of the case 10 and the arm extends to the rear end in the loading direction so that the roller 790a fitted to the end of the arm rotates on the surface of the cartridge shell. The arm 790 is biased downwardly (to the cartridge) by a spring not shown.

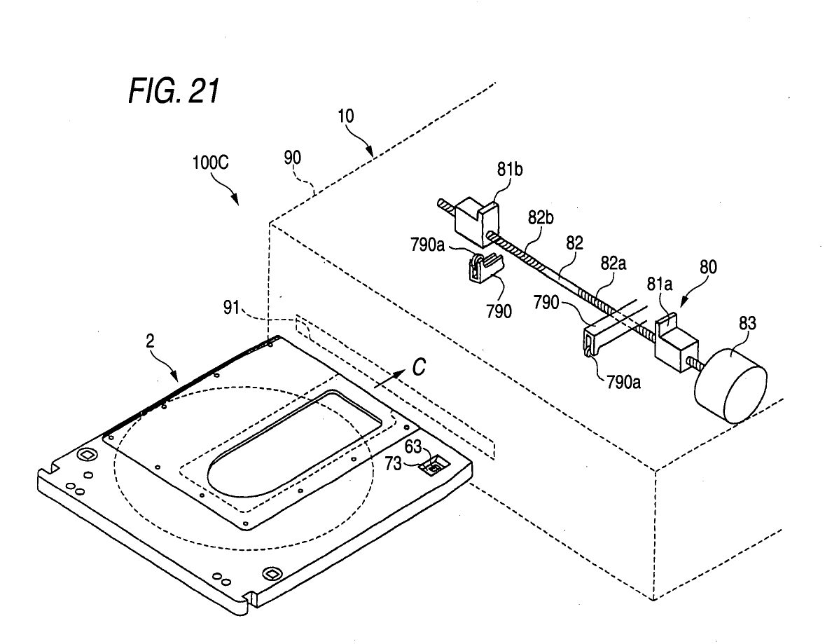

In addition, since both surfaces of the recording disk 4 (FIG. 10) can be subjected to the recording operation, the cartridge 2 is loaded into the recording and reproducing apparatus 10 in the state where one of the A surface 2a and the B surface 2b of the cartridge 2 is directed upward. When the loading surface is changed, the position of the arm 790 of the locking mechanism is laterally inverted. Accordingly, an arm 790 for inverted loading is additionally provided so as to engage with the through hole 201 when the cartridge 2 is inversely loaded (see FIG. 21).

The arms 790 and 790 fitted with a pair of rollers 790a and 790a are biased downwardly by a spring not shown. Accordingly, when one roller 790a is inserted, the other roller 790a maintains its contact with the surface of the cartridge 2, thereby not interfering with each other.

<Operation of Unlocking Mechanism>

Next, an operation of the unlocking mechanism will be described.

When the leading end of the photosensitive recording medium cartridge 2 is inserted into the loading slot 91 (FIG. 21) and goes ahead, the roller 790a of the end of the arm 790 of the unlocking mechanism is placed on the cartridge 2 (see FIG. 18(1)).

When the insertion of the cartridge 2 advances, the roller 790a comes close to the through hole 201 (see FIG. 18(2)). At this time, the convex portion 202c formed at the leading end in the insertion direction of the sliding member 202 maintains the engagement with the concave portion 56e formed in the shutter 56 (see the right side in the figure).

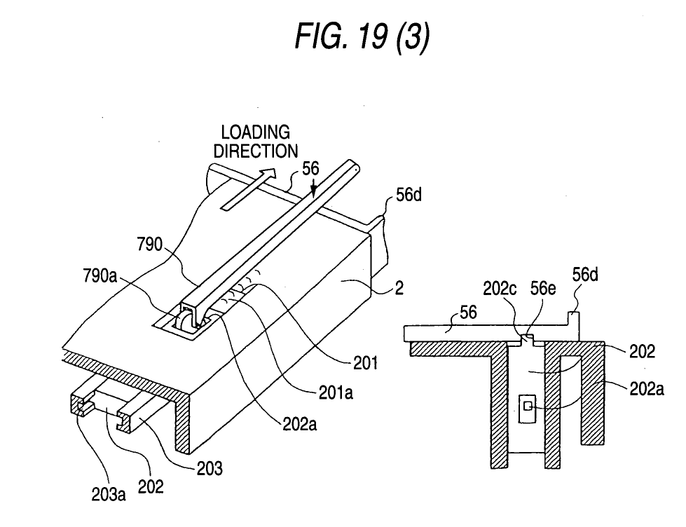

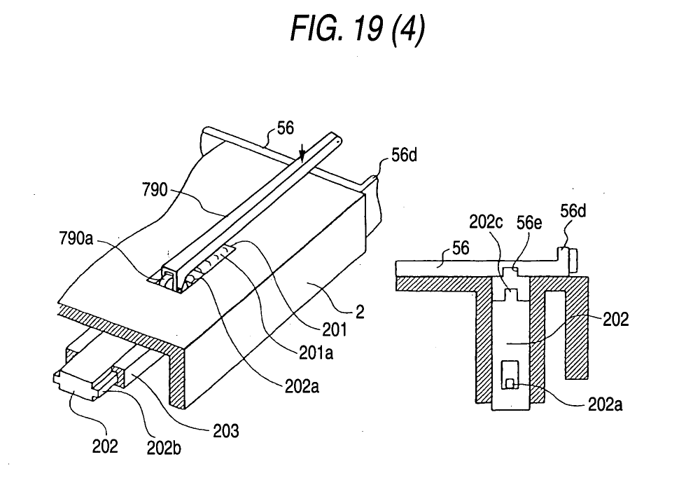

When the insertion of the cartridge 2 further advances, the roller 790a rolls down on the slope of the through hole 201 and enters the small hole 202a of the sliding member 202 (see FIG. 19(3)). At this time, since the sliding member 202 does not slide yet, the convex portion 202c of the sliding member 202 maintains the engagement with the concave portion 56e of the shutter 56 (see the right side in the figure).

When the insertion of the cartridge 2 further advances, the roller 790a enters the small hole 202a of the sliding member 202 and pushes down the sliding member 202 toward the rear end in the loading direction (see FIG. 19(4)). The convex portion 202c of the sliding member 202 departs from the concave portion 56e of the shutter 56 and then goes down downwardly in the figure (see the right side in the figure). At this position, the loading operation of the cartridge 2 is ended.

<Operation of Shutter Opening Mechanism>

When the shutter is unlocked as described above, the illumination sensor checks the shielding of light (which will be described later) and then the shutter is opened as follows.

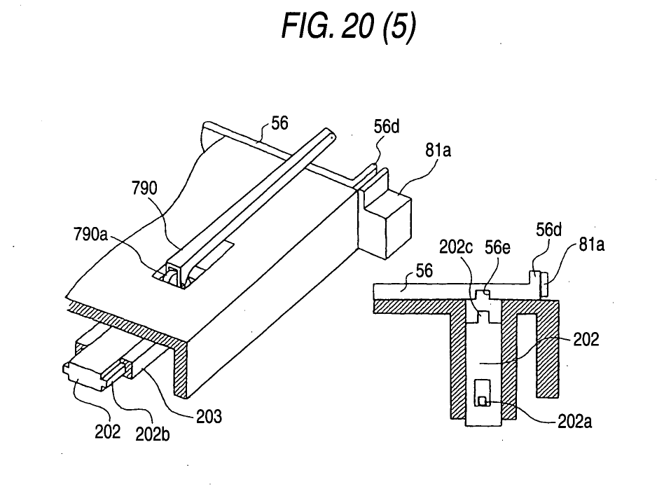

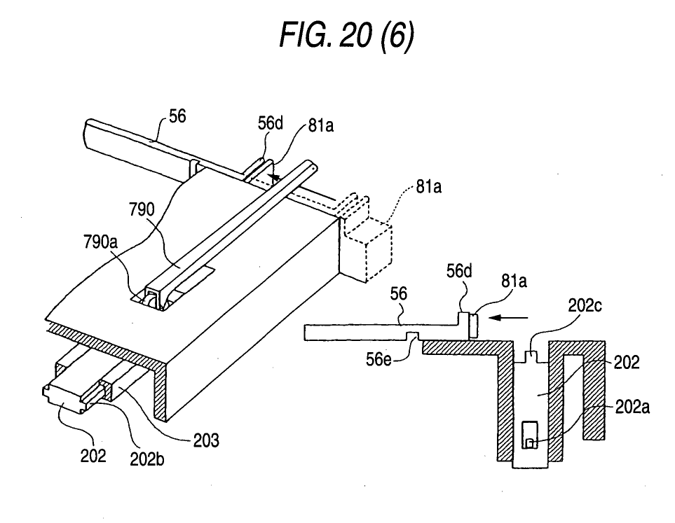

When the driving motor of the shutter opening mechanism 80 (FIG. 21) rotates, the lead screw 82 fixed to the rotation shaft rotates and the operating piece 81a (see FIG. 20) approaches and presses the operable portion 56d, thereby allowing the shutter 13 (FIG. 21) to slide to the opening position (FIG. 20(5)).

When the driving motor 83 further rotates, the operating piece 81a allows the shutter 13 (FIG. 21) to the opening position, then the rotation of the driving motor 83 is ended, and the sliding is ended (FIG. 20(6)). Thereafter, a recording or reproducing operation is started.

Although it has been described that the unlocking mechanism includes the arm 790 and the roller 790a provided at the end thereof, the unlocking mechanism of the invention is not limited to the structure.

For example, the sliding member 202 used in FIGS. 18 to 20 can be modified as follows and the unlocking mechanism may be modified to correspond to the modification of the sliding member.

The sliding member 202 is allowed to slide along the inner wall of the cartridge and a longitudinal hole is formed in the wall of the cartridge by a length corresponding to the stroke for releasing the engagement in the cartridge loading direction. A protrusion extending from the sliding member 202, passing through the longitudinal hole (that is, passing through the wall of the cartridge), and protruding from the side surface of the cartridge is formed in the sliding member 202. By providing the recording and reproducing apparatus with a stopper suppressing the approach of the protrusion at the time of loading the cartridge, the advancement of the protrusion (that is, the sliding member) is hindered by the stopper when the cartridge goes to a predetermined position. Accordingly, when the cartridge reaches the predetermined position, only the sliding member slides backwardly and the state shown in FIG. 19(4) is obtained. The convex portion 202c of the sliding member 202 departs from the concave portion 56e of the shutter 56 and goes down in the figure, the loading of the cartridge 2 is ended at the position, and then the shutter can be opened.

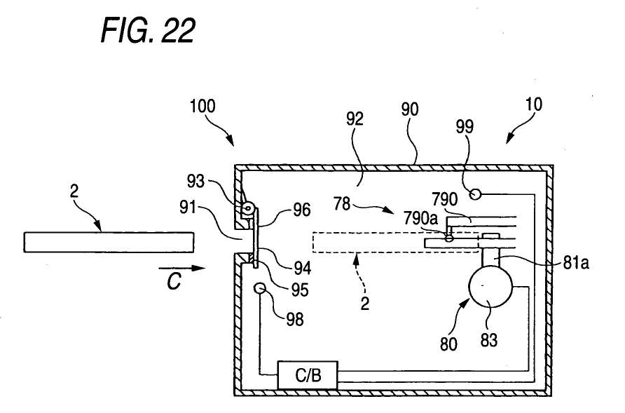

FIGS. 21 and 22 are diagrams schematically illustrating a configuration of a recording and reproducing apparatus. As shown in FIGS. 21 and 22, a recording and reproducing apparatus 10 loading a cartridge 2 therein for use includes a case 90 having a loading slot 91 into which the cartridge 2 can be loaded and an inner space 92 shielded from external light. The loading slot 91 is opened and closed by a loading slot shutter 94 disposed inside the case 90 to be rotatable about a pin 93. The loading slot shutter 94 engages with an end of a twist coil spring 96 and is thus biased in a closing direction of the loading slot shutter 94. A light shielding member 95 is bonded to the entire opening circumference of the loading slot 91 and shields the loading slot 91 from external light in cooperation with the loading slot shutter 94 when the loading slot shutter 94 is closed.

The unlocking mechanism 78 and the shutter opening mechanism 80 are built in the case 90.

The shutter opening mechanism 80 includes a pair of operating pieces 81a and 81b coming in contact with the outsides of operable portions 56d of the sliding member 56 and a lead screw 82 in which a right screw 82a and a left screw 82b are formed at both ends thereof, respectively. The operating piece 81a is screwed to the right screw 82a of the lead screw 82 and the operating piece 81b is screwed to the left screw 82b. A rotation shaft of a driving motor 83 is fixed to one end of the lead screw 82 to allow the lead screw 82 to rotate in a clockwise or counterclockwise direction.

When the lead screw 82 rotate in the counterclockwise direction, the operating pieces 81a and 81b move close to each other and pressurizes the pressure portions 56d, thereby allowing the shutter 13 to slide to an opening position. Two operating pieces 81a and 81b are provided so as to cope with the inverted loading of the cartridge 2.

The illumination sensor (FIG. 22) detecting the brightness in the case 90 is disposed in the case 90. FIG. 6 is a diagram illustrating a detection flow of the illumination sensor 98.

Referring to the figure, the illumination sensor 98 detects the brightness in the case 90 before the cartridge 2 unlocked as described above reaches a predetermined position. When the illumination is lower than or equal to a predetermined value, it is judged that the case body 90 is shielded from light (S2) and the lead screw 82 is allowed to rotate in the counterclockwise by activating the driving motor 83 (S3). Accordingly, the operating pieces 81a and 81b screwed to the right screw 82a and the left screw 82b of the lead screw 82 move close to each other and press the operable portion 56d, thereby opening the shutter 13. Then, data are recorded or recorded data are produced by a head not shown while allowing the recording disk 4 to rotate.

When the illumination detected by the illumination sensor 98 is higher than a predetermined value (S2), the recording disk 4 may be exposed to light. Accordingly, without opening the shutter 13, a user is allowed to take notice thereof by displaying an alarm on a display unit (not shown) or discharging the cartridge 2 (S4).

In this way, since the locking mechanism 27 is automatically unlocked by inserting the cartridge 2 into the recording and reproducing apparatus 10 and the shutter 13 is opened after the recording and reproducing apparatus 10 is shielded from light, it is possible to surely prevent the exposure of the recording disk 4 to light.

FIGS. 7 to 9 are perspective views illustrating an outer shape of a holographic recording medium cartridge (hereinafter, abbreviated as a cartridge), wherein FIG. 7 is a perspective view illustrating a state where one surface of the cartridge is directed upward, FIG. 8 is a perspective view illustrating a state where the other surface is directed upward, and FIG. 9 is a perspective view illustrating a state where the shutter is located at the opening position and the disk-shaped holographic recording medium (hereinafter, referred to as a recording disk) is rotatably received in a disk receiving portion.

Then, the cartridge 2 having the light-shielding mechanisms according to the third embodiment of the invention will be described. As shown in FIGS. 7 to 9, the cartridge 2 is loaded into the recording and reproducing apparatus 10 such as a holographic recording apparatus using the cartridge in the direction of arrow C. Both side surfaces of the leading end of the cartridge 2 is provided with the positioning grooves 7 (FIG. 7) and 8 (FIG. 8) into which positioning members formed in the recording and reproducing apparatus 10 when the cartridge 2 is loaded into the recording and reproducing apparatus 10 such as the holographic recording apparatus.

The recording disk 4 is a holographic recording disk having a hole formed through the center thereof and a disk shape and holographic recording layers are formed on both surfaces thereof. Data are recorded as interference fringes of laser beams in the holographic recording layers in a multi-layered manner by means of the laser beams in the wavelength band of green 532 nm to blue 405 nm. The cartridge 2 is loaded in the recording and reproducing apparatus (holographic recording apparatus) 10 with any one of an A surface 2a and a B surface 2b directed upward so as to record data on both recording surfaces of the recording disk 4.

The cartridge 2 includes a cartridge body 11 provided with a disk receiving portion 3, a light shielding plate 12 sandwiching the outside of the cartridge body 11, and a shutter 13 fitted between the cartridge body 11 and the light shielding plate 12. Substantially rectangular outer openings 14 and 15 as second openings are formed in the top and bottom surfaces of the light shielding plate 12. The outer openings 14 and 15 are closed by a first shutter 55a and a second shutter 55b when the shutter 13 is at a closing position.

As shown in FIG. 9, when the shutter 13 moves to the opening position in the direction of arrow D, inner openings 18 and 19, which are formed in the cartridge body 11 so as to oppose the outer openings 14 and 15 and have the same shape, are opened along with the outer openings 14 and 15. Accordingly, the central portion 4a and the recording surface 4b of the recording disk 4 received in the disk receiving portion 3 are exposed.

The shutter 13 is biased to the closing position by a built-in shutter spring and is locked at the closing position by the locking mechanism. The locking mechanism is unlocked by inserting the second locking member 64 protruding in the positioning groove 7 into the cartridge 2 and allowing the first locking member 63, which is exposed from the openings 73 and 72 of the A surface 2a and the B surface 2b of the cartridge 2 in that state, to the rear end in the cartridge loading direction. In this way, since the shutter 13 is locked at the closing position by the locking mechanism, which is unlocked only by a two-step operation, the shutter 13 is not opened carelessly.

FIG. 10 is an exploded perspective view illustrating a configuration of a cartridge, FIG. 11 is a cross-sectional view taken along arrow VI-VI in FIG. 10, and FIG. 12 is a cross-sectional view taken along arrow VII-VII in FIG. 10. FIG. 13A is a cross-sectional view taken along the loading direction of the cartridge, FIG. 13B is an enlarged view illustrating a leading end portion of FIG. 13A, and FIG. 13C is an enlarged view illustrating a read end portion of FIG. 13A. FIG. 14 is a cross-sectional view taken along a direction perpendicular to the loading direction of the cartridge, where FIG. 14A is a cross-sectional view illustrating a state where the shutter is closed and FIG. 14B is a cross-sectional view illustrating a state where the shutter is opened. FIG. 15 is an enlarged view illustrating a part surrounded with a circle X in FIG. 14 and FIG. 16 is an enlarged view illustrating a part surrounded with a circle XI in FIG. 14.

As shown in FIG. 10, the cartridge body 11 includes a substantially plate-shaped first shell 25, a second shell 26 bonded to the first shell 25, and a locking mechanism 27 which is fitted between the first shell 25 and the second shell 26 so as to lock the shutter 13.

The first shell 25 and the second shell 26 are formed of an equal or similar thermoplastic to which a light shielding material and a lubricant are added by the use of an extrusion molding method. As shown in FIG. 13C which is an enlarged sectional view illustrating the read end portion of the cartridge 2, a first light shielding wall 30 as a protrusion having a diameter larger than the outer diameter of the recording disk 4, a second light shielding wall 31 disposed outside the first light shielding wall 30, and a protrusion 32 disposed in the entire outer circumferential edge are provided on the inner surface of the first shell 25. An inner opening 18 for exposing the central portion 4a and the recording surface 4b of the recording disk 4 is formed inside the first light shielding wall 30.

A third light shielding wall 35 which is a protrusion having a diameter larger than the outer diameter of the recording disk 4 and is interposed between the first light shielding wall 30 and the second light shielding wall 31 of the first shell 25 and a protrusion 36 formed on the entire outer circumferential edge are provided on the inner surface of the second shell 26. An inner opening n19 for exposing the central portion 4a and the recording surface 4b of the recording disk 4 is formed inside the third light shielding wall 35.

When the recording disk 4 is placed inside the third light shielding wall 35 of the second shell 26 and the first shell 25 is placed on the second shell 26, the third light shielding wall 35 is inserted between the first light shielding wall 30 and the second light shielding wall 31 and the end of the third light shielding wall 35 comes in contact with the inner surface 25e of the first shell 25. The disk receiving portion 3 is defined by the light shielding walls 30, 31, and 35, the first shell 25, and the second shell 26. The sidewall of the disk receiving portion 3 has a labyrinth-shaped light shielding structure in which three light shielding walls 30, 31, and 35 are mixed and combined. Accordingly, even when light or dust is invaded through the bonding portion of the first shell 25 and the second shell 26, it does not enter the disk receiving portion 3.

The end of the third light shielding wall 35 of the second shell 26 is fixed to the inner surface 25e of the first shell 25 by means of an ultrasonic welding method. Accordingly, since the first shell 25 and the second shell 26 are strongly bonded to each other, the bonding portion therebetween does not have any gap.

As shown in FIGS. 10 and 13 to 16, stepped portions 25d and 26d having a size slightly larger than that of the light shielding plate 12 and a depth larger than the thickness of the light shielding plate 12 and light-shielding plate fitting surfaces 25a and 26a offset inwardly are formed in the outer surfaces of the first shell 25 and the second shell 26.

The light shielding plate 12 is made of, for example, an aluminum alloy having a light shielding property, a corrosion resistant property, a decorative property, and a processible property and having a small weight and strength. The light shielding plate 12 may be formed of a plastic material. In this case, a plastic material to which a light shielding material and a lubricant are added may be used to secure the light shielding property and sliding property of the shutter 13.

As shown in FIGS. 10 to 12, the light shielding plate 12 is obtained by forming the outer openings 14 and 15 and a cut for making it possible for the shutter 13 to move in a thin plate made of an aluminum alloy and then bending the thin plate to have a substantially ⊃-shaped section. Accordingly, a first plate portion 12a and a second plate portion 12b having the outer openings 14 and 15, respectively, and a third plate portion 12c having the cut 40 and connecting the first plate portion 12a and the second plate portion 12b are provided in the light shielding plate 12.

Incisions are formed in ridge portions between the third plate portion 12c and the first and second plate portions 12a and 12b and intersections between two sides in the loading direction C of the cartridge 2 and one side in the direction perpendicular to the loading direction C and the outer circumferential edges of the first plate portion 12a and the second plate portion 12b are bent in the direction (in other words, a direction directed to the cartridge body 11 when it is fitted into the cartridge body 11) close to each other in a substantially ˆ shape. Accordingly, substantially ˆ-shaped bent portions 12d are formed in the outer circumferential edges of the first plate portion 12a and the second plate portion 12b. It is preferable in view of light shielding performance that the bent portions 12d are formed in three sides of the outer circumferential edges, but the invention is not limited to it.

The light shielding plate 12 is fitted to the light-shielding plate fitting surfaces 25a and 26a of the cartridge body 11, so that the B surface 2b and the A surface 2a of the cartridge body 11 are interposed between the first plate portion 12a and the second plate portion 12b and the front end in the loading direction C of the cartridge body 11 is covered with the third plate portion 12c. Since the light-shielding plate fitting surface 25a and 26a are offset inwardly with a depth larger than the thickness of the light shielding plate 12, the outer surface of the light shielding plate 12 fitted to the cartridge body 11 does not protrude from the surface of the cartridge 2. As shown in FIGS. 13 to 16, the ends of the bent portions 12d of the first plate portion 12a and the second plate portion 12b are opposed to the stepped portions 25d and 26d of the first shell 25 and the second shell 26.

As shown in FIG. 10, small holes 49 are formed with a constant interval in the outer circumferences of the first plate portion 12a and the second plate portion 12b of the light shielding plate 12. In the light-shielding plate fitting surfaces 25a and 26a of the first shell 25 and the second shell 26, pins 50 having a length slightly larger than the thickness of the light shielding plate 12 are integrally formed at positions corresponding to the holes 49 of the light shielding plate 12.

As shown in FIGS. 13 to 16, when the light shielding plate 12 is fitted to the outside (the light-shielding plate fitting surfaces 25a and 26a) of the cartridge body 11, the pins of the first shell 25 and the second shell 26 are inserted into the holes 49 and protrudes from the surface of the light shielding plate 12. In the light shielding plate 12, the ends of the bent portions 12d are pressed to the light-shielding plate fitting surfaces 25a and 26a and the ends of the pins 50 are crushed by heat, thereby fixing the ends to the cartridge body 11.

Accordingly, the ends of the bent portions 12d of the light shielding plate 12 are opposed to the stepped portions 25d and 26d and are pressed to the light-shielding plate fitting surfaces 25a and 26a by means of an elastic force of the light shielding plate 12 to come in contact therewith without any gap. That is, the outer edges (the ends of the bent portions 12d) of the light shielding plate 12 and the light-shielding plate fitting surfaces 25a and 26a come in close contact with each other without any gap. In addition, since the outer edges of the light shielding plate 12 are covered with the stepped portions 25d and 26d. As a result, even when a gap partially exists due to an error in precision of components, the invasion of light can be surely prevented, thereby surely blocking light.

In addition, as a method of fixing the light shielding plate 12 to the cartridge body 11, an adhesive, a double-sided tape, a screw coupling, and the like may be used. When the light shielding plate 12 is formed of a plastic material, a variety of welding methods may be used.

As shown in FIG. 10, the shutter 13 includes a shutter member 55 obtained by bending a thin plate having a light shielding property in a substantially ⊃ shape and a longitudinal and narrow plate-shaped sliding member 56. The shutter member 55 is made of, for example, an aluminum alloy for the same reason as the light shielding plate 12. The shutter member 55 may be made of a plastic material and may be made of a plastic material to which a light shielding material and a lubricant are added to secure the light shielding property and the slidable property. The sliding member 56 is made of a plastic material to which a light shielding material and a lubricant are added.

The shutter member 55 includes a first shutter 55a interposed between the outer surface of the first shell 25 and the first plate portion 12a of the light shielding plate 12, a second shutter 55b interposed between the outer surface of the second shell 26 and the second plate portion 12b of the light shielding plate 12, and a connection portion 55c which extends from the first shutter 55a and the second shutter 55b and to which the sliding member 56 is fitted.

On the outer surfaces of the first shell 25 and the second shell 26, shutter sliding surfaces 25b and 26b offset inwardly with a depth larger than the thickness of the shutter member 55 are formed inside the light-shielding plate fitting surfaces 25a and 26a. Accordingly, since the shutter 13 can smoothly move between the cartridge body 11 and the light shielding plate 12, it is possible to prevent scraping due to the movement. The shutter sliding surfaces 25b and 26b may be roughened to scatter the incident light. Similarly, the inner surface of the light shielding plate 12 and the inner surface and the outer surface of the shutter 13 may be roughened.

The sliding member 56 is slidably fitted between the first shell 25 and the second shell 26 so that the top surface thereof is exposed from the end surface in the loading direction of the cartridge body 11. The top end of the sliding member 56 is provided with a fitting surface 56a which is fitted to the inner surface of the connection portion 55c of the shutter member 55. For example, two pins 56b are integrally formed on the fitting surface 56a and are inserted into two holes 55d formed in the connection portions 55c, and the tips thereof are crushed by heat, thereby fixing the shutter member 55 and the sliding member 56 to each other. An adhesive or a double-sided tape, or the like may be used for the fixing. When the shutter member 55 is made of a plastic material, a variety of welding methods may be used. A screw fixing method may be used.

As shown in FIGS. 13B, grooves 56c are formed in the side surfaces of the sliding member 56 in the longitudinal direction. Protrusions 35c and 26c formed on the inner surface of the first shell 25 and the second shell 26 at the end in the loading direction are inserted into the grooves 56c. The sliding member 56 can slide without departing from the cartridge body 11 by the use of the grooves 56c and the protrusions 25c and 26c.

An operable portion 56d to be operated at the time of opening the shutter 13 is integrally formed at the other end of the top of the sliding member 56. The operable portion 56d is exposed without being covered with the third plate portion 12c of the light shielding plate 12 by allowing the sliding member 56 to extend in the direction in which the shutter is closed with respect to the shutter member 55. The cut 40 of the third plate portion 12c of the light shielding plate 12 is provided to avoid the interference with the operable portion 56d when the shutter 13 moves to the opening position (see FIG. 9).

The shutter 13 is biased in the closing direction by the shutter spring 59. The shutter spring 59 is formed of, for example, a torsion coil spring and both ends thereof are fixed to the sliding member 56 and the inner surface of the first shell 25.

The ultrasonic welding method has been used for bonding the first shell and the second shell to each other and other welding or fixing methods may be used. For example, when a screw coupling method is used, a light shielding structure may be formed around the screw hole. Each of the second shell and the first shell has been composed of one component, but a plurality of components may be combined. For example, when each shell is composed of two components, it is possible to simplify the mold.

Although the cartridge receiving a recording disk of which both surfaces can be subjected to a recording operation has been described, the invention may be applied to a recording disk of which one surface is subjected to a recording operation. In this case, the opening is formed only one surface and the opening is opened and closed by a shutter. Although the cartridge receiving a holographic recording medium has been described, the invention can be applied to other cartridges receiving a recording medium having a photosensitivity.

This application is based on Japanese Patent application JP 2005-269792, filed Sep. 16, 2005, Japanese Patent application JP 2005-269841, filed Sep. 16, 2005, and Japanese Patent application JP 2005-289003, filed Sep. 30, 2005, the entire contents of which are hereby incorporated by reference, the same as if set forth at length.

What is claimed is:

1. A recording and reproducing apparatus for a photosensitive recording medium, the apparatus comprising:
a case having a loading slot, which a photosensitive recording medium cartridge can be inserted into, and an inner space shielded from an outside, the photosensitive recording medium cartridge including a cartridge body rotatably receiving the photosensitive recording medium and having an opening for exposing a central portion and a recording surface of the photosensitive recording medium to an outside, a shutter fitted to an outside of the cartridge body and disposed to be movable between a closing position where the opening is closed and an opening position where the opening is opened, and a locking mechanism for locking the shutter at the closing position;
an loading slot shutter which is disposed in the case so as to open and close the loading slot and which shields the loading slot from the outside when the loading slot is closed;
an unlocking mechanism which is disposed in the case and which is for unlocking locking members of the locking mechanism, the locking mechanism including a first locking member which is movable between a first locking position for blocking movement of the shutter to the opening position and a first unlocking position for permitting the movement of the shutter to the opening position and a second locking member which is movable between a second locking position for blocking movement of the first locking member to the first unlocking position and a second unlocking position for permitting the movement of the first locking member to the first unlocking position; and
a shutter opening mechanism which is disposed in the case and which is for opening the shutter of the photosensitive recording medium cartridge,
wherein the unlocking mechanism starts the unlocking of the second locking member immediately after a leading end of the photosensitive recording medium cartridge is inserted into the loading slot and starts the unlocking of the first locking member immediately after the second locking member is unlocked, and
wherein the shutter opening mechanism opens the shutter of the photosensitive recording medium cartridge when the photosensitive recording medium cartridge reaches a predetermined position.

2. The recording and reproducing apparatus for a photosensitive recording medium according to claim 1, wherein the unlocking mechanism is movable in a horizontal direction in the case.

3. The recording and reproducing apparatus for a photosensitive recording medium according to claim 2, further comprising an end detecting sensor detecting that the leading end of the photosensitive recording medium cartridge is inserted into the loading slot,
wherein the unlocking mechanism is allowed to move in the horizontal direction in response to an output of the end detecting sensor.

4. The recording and reproducing apparatus for a photosensitive recording medium according to claim 1, wherein the shutter has a bent portion, which is bent toward the cartridge body, at an outer circumferential edge of the shutter and the cartridge body has a protruded portion formed at a position corresponding to the outer circumferential edge.

5. The recording and reproducing apparatus for a photosensitive recording medium according to claim 4, wherein the bent portion is formed at an end of the outer circumferential edge close to the opening position of the shutter.

6. The recording and reproducing apparatus for a photosensitive recording medium according to claim 4, wherein the shutter includes a first light shielding plate portion being capable of sliding so as to open and close the opening, a second light shielding plate portion rising vertically from an end of the first light shielding plate portion close to the opening position of the shutter, and a third light shielding plate portion rising vertically from the second light shielding plate portion in a direction in which the shutter is closed, and
wherein the cartridge body is provided with a protrusion which is interposed between the first light shielding plate portion and the third light shielding plate portion when the shutter is at the closing position.

7. The recording and reproducing apparatus for a photosensitive recording medium according to claim 4, wherein the shutter includes a first light shielding plate portion being capable of sliding so as to open and close the opening and a second light shielding plate portion rising vertically from an end of the first light shielding portion close to the opening position of the shutter, and
wherein the protruded portion has: a protrusion top surface which is provided so as to be opposed to the first light shielding plate portion when the shutter is at the closing position; and a protrusion side surface which is provided so as to be opposed to the second light shielding plate portion when the shutter is at the closing position.

8. The recording and reproducing apparatus for a photosensitive recording medium according to claim 4, wherein the shutter includes a first light shielding plate portion being capable of sliding so as to open and close the opening, a second light shielding plate portion rising vertically from an end of the first light shielding plate portion close to the opening position of the shutter, and a third light shielding plate portion rising vertically from the second light shielding plate portion in a direction in which the shutter is opened, and
wherein the cartridge body has a protrusion top surface which is provided so as to be opposed to the first light shielding plate portion when the shutter is at the closing position, a protrusion side surface which is provided so as to be opposed to the second light shielding plate portion when the shutter is at the closing position, and a shutter sliding surface offset inwardly in the protrusion top surface and provided so as to be opposed to the third light shielding plate portion when the shutter is at the closing position.

9. The recording and reproducing apparatus for a photosensitive recording medium according to claim 1, wherein an inner surface of the cartridge body opposed to the photosensitive recording medium and an outer surface of the cartridge body opposed to the shutter are matted or embossed with a surface roughness Ra of 5 to 20 μm.

10. The recording and reproducing apparatus for a photosensitive recording medium according to claim 1, wherein the cartridge body includes a first shell having a substantially plate shape and a second shell welded to the first shell to overlap with each other, the first shell and the second shell are made from an equal or similar thermoplastic material, and other components of the photosensitive recording medium cartridge including the shutter are made from a material different from that of the first shell and the second shell.

11. The recording and reproducing apparatus for a photosensitive recording medium according to claim 10, wherein 0.01 weight % to 5.00 weight % of a light shielding material is added to a plastic used for forming each of the first shell, the second shell, and the shutter.

12. The recording and reproducing apparatus for a photosensitive recording medium according to claim 10, wherein 0.01 weight % to 2.00 weight % of carbon black is added to a plastic used for forming each of the first shell, the second shell, and the shutter.

13. The recording and reproducing apparatus for a photosensitive recording medium according to claim 10, wherein 0.1 weight % to 5.0 weight % of a silicon-based lubricant is added to a plastic used for forming each of the first shell, the second shell, and the shutter.

14. The recording and reproducing apparatus for a photosensitive recording medium according to claim 1, wherein the photosensitive recording medium is a holographic recording medium.

15. A recording and reproducing apparatus for a photosensitive recording medium, the apparatus comprising:
a case having a loading slot, which a photosensitive recording medium cartridge can be inserted into, and an inner space shielded from an outside, the photosensitive recording medium cartridge including a cartridge body rotatably receiving the photosensitive recording medium and having an opening for exposing a central portion and a recording surface of the photosensitive recording medium to an outside, a shutter fitted to an outside of the cartridge body and disposed to be movable between a closing position where the opening is closed and an opening position where the opening is opened, and a locking mechanism for locking the shutter at the closing position;
an loading slot shutter which is disposed in the case so as to open and close the loading slot and which shields the loading slot from the outside when the loading slot is closed;
an unlocking mechanism which is disposed in the case and which is for unlocking locking members of the locking mechanism, the locking mechanism including a first locking member which is movable between a first locking position for blocking movement of the shutter to the opening position and a first unlocking position for permitting the movement of the shutter to the opening position and a second locking member which is movable between a second locking position for blocking movement of the first locking member to the first unlocking position and a second unlocking position for permitting the movement of the first locking member to the first unlocking position; and
a shutter opening mechanism which is disposed in the case and which is for opening the shutter of the photosensitive recording medium cartridge,
wherein the unlocking mechanism starts the unlocking of the second locking member immediately after a leading end of the photosensitive recording medium cartridge is inserted into the loading slot and starts the unlocking of the first locking member immediately after the second locking member is unlocked, and
wherein the shutter opening mechanism opens the shutter of the photosensitive recording medium cartridge immediately after the first locking member is unlocked and the shutter is opened when the photosensitive recording medium cartridge reaches a predetermined position.

16. The recording and reproducing apparatus for a photosensitive recording medium according to claim 15, wherein the unlocking mechanism and the shutter opening mechanism are movable in a horizontal direction in the case.

17. The recording and reproducing apparatus for a photosensitive recording medium according to claim 16, further comprising an end detecting sensor detecting that the leading end of the photosensitive recording medium cartridge is inserted into the loading slot,
wherein the unlocking mechanism is allowed to move in the horizontal direction in response to an output of the end detecting sensor.

18. The recording and reproducing apparatus for a photosensitive recording medium according to claim 15, wherein the shutter has a bent portion, which is bent toward the cartridge body, at an outer circumferential edge of the shutter and the cartridge body has a protruded portion formed at a position corresponding to the outer circumferential edge.

19. The recording and reproducing apparatus for a photosensitive recording medium according to claim 18, wherein the bent portion is formed at an end of the outer circumferential edge close to the opening position of the shutter.

20. The recording and reproducing apparatus for a photosensitive recording medium according to claim 18, wherein the shutter includes a first light shielding plate portion being capable of sliding so as to open and close the opening, a second light shielding plate portion rising vertically from an end of the first light shielding plate portion close to the opening position of the shutter, and a third light shielding plate portion rising vertically from the second light shielding plate portion in a direction in which the shutter is closed, and
wherein the cartridge body is provided with a protrusion which is interposed between the first light shielding plate portion and the third light shielding plate portion when the shutter is at the closing position.

21. The recording and reproducing apparatus for a photosensitive recording medium according to claim 18, wherein the shutter includes a first light shielding plate portion being capable of sliding so as to open and close the opening and a second light shielding plate portion rising vertically from an end of the first light shielding portion close to the opening position of the shutter, and
wherein the protruded portion has: a protrusion top surface which is provided so as to be opposed to the first light shielding plate portion when the shutter is at the closing position; and a protrusion side surface which is provided so as to be opposed to the second light shielding plate portion when the shutter is at the closing position.

22. The recording and reproducing apparatus for a photosensitive recording medium according to claim 18, wherein the shutter includes a first light shielding plate portion being capable of sliding so as to open and close the opening, a second light shielding plate portion rising vertically from an end of the first light shielding plate portion close to the opening position of the shutter, and a third light shielding plate portion rising vertically from the second light shielding plate portion in a direction in which the shutter is opened, and
wherein the cartridge body has: a protrusion top surface which is provided so as to be opposed to the first light shielding plate portion when the shutter is at the closing position; a protrusion side surface which is provided so as to be opposed to the second light shielding plate portion when the shutter is at the closing position; and a shutter sliding surface offset inwardly in the protrusion top surface and provided so as to be opposed to the third light shielding plate portion when the shutter is at the closing position.

23. The recording and reproducing apparatus for a photosensitive recording medium according to claim 15, wherein an inner surface of the cartridge body opposed to the photosensitive recording medium and an outer surface of the cartridge body opposed to the shutter are matted or embossed with a surface roughness Ra of 5 to 20 μm.

24. The recording and reproducing apparatus for a photosensitive recording medium according to claim 15, wherein the cartridge body includes a first shell having a substantially plate shape and a second shell welded to the first shell to overlap with each other, the first shell and the second shell are made from an equal or similar thermoplastic material, and other components of the photosensitive recording medium cartridge including the shutter are made from a material different from that of the first shell and the second shell.

25. The recording and reproducing apparatus for a photosensitive recording medium according to claim 24, wherein 0.01 weight % to 5.00 weight % of a light shielding material is added to a plastic used for forming each of the first shell, the second shell, and the shutter.

26. The recording and reproducing apparatus for a photosensitive recording medium according to claim 24, wherein 0.01 weight % to 2.00 weight % of carbon black is added to a plastic used for forming each of the first shell, the second shell, and the shutter.

27. The recording and reproducing apparatus for a photosensitive recording medium according to claim 24, wherein 0.1 weight % to 5.0 weight % of a silicon-based lubricant is added to a plastic used for forming each of the first shell, the second shell, and the shutter.

28. The recording and reproducing apparatus for a photosensitive recording medium according to claim 15, wherein the photosensitive recording medium is a holographic recording medium

29. A recording and reproducing apparatus for a photosensitive recording medium, the apparatus comprising:
a case having a loading slot, which a photosensitive recording medium cartridge can be inserted into, and an inner space shielded from an outside, the photosensitive recording medium cartridge including a cartridge body rotatably receiving the photosensitive recording medium and having an opening for exposing a central portion and a recording surface of the photosensitive recording medium to an outside, a shutter fitted to an outside of the cartridge body and disposed to be movable between a closing position where the opening is closed and an opening position where the opening is opened, and a locking mechanism for locking the shutter at the closing position;
an loading slot shutter which is disposed in the case so as to open and close the loading slot and which shields the loading slot from the outside when the loading slot is closed;
an unlocking mechanism which is disposed in the case and which is for unlocking a locking member of the locking mechanism, the locking member being movable between a first locking position for blocking movement of the shutter to the opening position and a first unlocking position for permitting the movement of the shutter to the opening position; and
a shutter opening mechanism which is disposed in the case and which is for opening the shutter of the photosensitive recording medium cartridge,
wherein the locking member includes a through hole formed through a cartridge shell disposed in a vicinity of a corner at a leading end in a loading direction of the photosensitive recording medium cartridge and a sliding member being capable of passing below the through hole and sliding toward a rear end in the loading direction from the leading end in the loading direction of the cartridge,
wherein a convex portion being capable of engaging with a concave portion formed in the shutter is formed at a leading end of the sliding member in the loading direction of the cartridge and a small hole is formed in the surface opposed to the through hole in a vicinity of a side of a leading end of the through hole in the loading direction of the cartridge,
wherein the unlocking mechanism includes an arm, which is rotatably disposed at a leading end of the case in the loading direction of the cartridge and which extends to the rear end in the loading direction therefrom, and an insertion member, which is fitted to an end of the arm and which is capable of moving on the cartridge shell to be inserted into the small hole,
wherein immediately before the leading end of the photosensitive recording medium cartridge reaches a stop position of the cartridge by inserting the leading end of the photosensitive recording medium cartridge into the loading slot, the insertion member of the unlocking mechanism enters the small hole of the sliding member from the through hole of the cartridge and the insertion member allows the sliding member to slide toward the rear end in the loading direction of the cartridge by means of an additional insertion of the leading end of the photosensitive recording medium cartridge, so that the convex portion of the sliding member engaging with the concave portion of the shutter is released from the engagement to be unlocked, and
wherein the shutter opening mechanism opens the shutter of the photosensitive recording medium cartridge after checking the shielding of light in the case.

30. The recording and reproducing apparatus for a photosensitive recording medium according to claim 29, wherein an illumination sensor is disposed in the case and a motor of the shutter opening mechanism is driven to rotate on a basis of an output of the illumination sensor.

31. The recording and reproducing apparatus for a photosensitive recording medium according to claim 29, wherein the insertion member is a roller and the through hole formed through the cartridge shell and the small hole of the sliding member have a smooth slope inclined to the rear ends from the leading ends of the through hole and the small hole in the loading direction of the cartridge.

32. The recording and reproducing apparatus for a photosensitive recording medium according to claim 29, wherein the shutter has a bent portion, which is bent toward the cartridge body, at an outer circumferential edge of the shutter and the cartridge body has a protruded portion formed at a position corresponding to the outer circumferential edge.

33. The recording and reproducing apparatus for a photosensitive recording medium according to claim 32, wherein the bent portion is formed at an end of the outer circumferential edge close to the opening position of the shutter.

34. The recording and reproducing apparatus for a photosensitive recording medium according to claim 32, wherein the shutter includes a first light shielding plate portion being capable of sliding so as to open and close the opening, a second light shielding plate portion rising vertically from an end of the first light shielding plate portion close to the opening position of the shutter, and a third light shielding plate portion rising vertically from the second light shielding plate portion in a direction in which the shutter is closed, and
wherein the cartridge body is provided with a protrusion which is interposed between the first light shielding plate portion and the third light shielding plate portion when the shutter is at the closing position.

35. The recording and reproducing apparatus for a photosensitive recording medium according to claim 32, wherein the shutter includes a first light shielding plate portion being capable of sliding so as to open and close the opening and a second light shielding plate portion rising vertically from an end of the first light shielding portion close to the opening position of the shutter, and
wherein the protruded portion has: a protrusion top surface which is provided so as to be opposed to the first light shielding plate portion when the shutter is at the closing position; and a protrusion side surface which is provided so as to be opposed to the second light shielding plate portion when the shutter is at the closing position.

36. The recording and reproducing apparatus for a photosensitive recording medium according to claim 32, wherein the shutter includes a first light shielding plate portion being capable of sliding so as to open and close the opening, a second light shielding plate portion rising vertically from an end of the first light shielding plate portion close to the opening position of the shutter, and a third light shielding plate portion rising vertically from the second light shielding plate portion in a direction in which the shutter is opened, and
wherein the cartridge body has: a protrusion top surface which is provided so as to be opposed to the first light shielding plate portion when the shutter is at the closing position; a protrusion side surface which is provided so as to be opposed to the second light shielding plate portion when the shutter is at the closing position; and a shutter sliding surface offset inwardly in the protrusion top surface and provided so as to be opposed to the third light shielding plate portion when the shutter is at the closing position.

37. The recording and reproducing apparatus for a photosensitive recording medium according to claim 29, wherein an inner surface of the cartridge body opposed to the photosensitive recording medium and an outer surface opposed to the shutter are matted or embossed with a surface roughness Ra of 5 to 20 μm.

38. The recording and reproducing apparatus for a photosensitive recording medium according to claim 29, wherein the cartridge body includes a first shell having a substantially plate shape and a second shell welded to the first shell to overlap with each other, the first shell and the second shell are made from an equal or similar thermoplastic material, and other components of the photosensitive recording medium cartridge including the shutter are made from a material different from that of the first shell and the second shell.

39. The recording and reproducing apparatus for a photosensitive recording medium according to claim 38, wherein 0.01 weight % to 5.00 weight % of a light shielding material is added to a plastic used for forming each of the first shell, the second shell, and the shutter.

40. The recording and reproducing apparatus for a photosensitive recording medium according to claim 38, wherein 0.01 weight % to 2.00 weight % of carbon black is added to a plastic used for forming each of the first shell, the second shell, and the shutter.

41. The recording and reproducing apparatus for a photosensitive recording medium according to claim 38, wherein 0.1 weight % to 5.0 weight % of a silicon-based lubricant is added to a plastic used for forming each of the first shell, the second shell, and the shutter.

42. The recording and reproducing apparatus for a photosensitive recording medium according to claim 29, wherein the photosensitive recording medium is a holographic recording medium
